(19) United States
(12) Patent Application Publication
(10) Pub. No.: US 2003/0166757 A1
(43) Pub. Date: Sep. 4, 2003

(54) Particulate coated flame-retardant for polymer

(76) Inventors: Hajime Nishihara, Yokohama-shi (JP); Toshiharu Sakuma, Kawasaka-shi (JP)

Correspondence Address: BIRCH STEWART KOLASCH & BIRCH, PO BOX 747, FALLS CHURCH, VA, 22040-0747, US

(21) Appl. No.: 10/344,275

(22) PCT Filed: Jun. 21, 2002
(86) PCT No.: PCT/JP02/06258

(30) Foreign Application Priority Data
Jun. 22, 2001 (JP) 2001-189972

(51) Int. Cl. C08K 3/18; C08K 3/22; C08K 9/12

(52) U.S. Cl. 524/430; 252/601; 252/604; 523/210

(57) ABSTRACT

Disclosed is a coated particulate flame retardant for a polymer, which comprises inorganic compound particles, each having, bonded to the surface thereof through a covalent bond, a coating compound so that the inorganic compound particle is coated with the coating compound, wherein the coated inorganic compound particles have an in situ-found number average particle diameter (α) in the range of from 1 to 1,000 nm, as measured with respect to the coated inorganic compound particles in a composition comprising a polymer having dispersed therein the coated inorganic compound particles.

### BACKGROUND OF THE INVENTION

1. Field of the Invention

The present invention relates to a coated particulate flame retardant for a polymer. More particularly, the present invention is concerned with a coated particulate flame retardant for a polymer, which comprises inorganic compound particles, each having, bonded to the surface thereof through a covalent bond, a coating compound so that the inorganic compound particle is coated with the coating compound, wherein the coated inorganic compound particles have an in situ-found number average particle diameter (α) in the range of from 1 to 1,000 nm, as measured with respect to the coated inorganic compound particles in a composition comprising a polymer having dispersed therein the coated inorganic compound particles. The coated particulate flame retardant of the present invention has excellent dispersibility in a polymer and also has great advantages in that, partly because of its excellent dispersibility in the polymer, not only can the polymer have remarkably improved flame retardancy, but also excellent appearance can be imparted to a shaped article produced from a polymer composition comprising the polymer and the coated particulate flame retardant. Further, the coated particulate flame retardant of the present invention is also advantageous in that the polymer can be prevented from suffering a lowering of stability thereof, especially heat stability, wherein the stability lowering of a polymer is likely to occur when the conventional, inorganic compound-containing flame retardants are used.

2. Prior Art

Thermoplastic polymers, such as a polycarbonate and a polystyrene, have excellent properties with respect to moldability, impact resistance and flexibility. Hence, thermoplastic polymers are used in a wide variety of fields, such as the fields of automobile-related materials, electricity-related materials and house-related materials.

In recent years, in the above-mentioned fields and the like, a method has been practiced in which inorganic compounds to thermoplastic polymers are added in order to improve the flame retardancy of the thermoplastic polymers. However, for imparting a high level of flame retardancy to a thermoplastic polymer by such a method, it is necessary to add a large amount of an inorganic compound to the polymer, so that the added inorganic compound exhibits poor dispersibility in the polymer, thus leading to a problem in that an ultimate shaped article suffers a lowering of appearance or mechanical strength. There has also been a problem in that, when an inorganic compound having many active sites is added to a polymer, the polymer has poor heat stability and hence it becomes susceptible to heat decomposition or the like.

In order to solve these problems, the below-mentioned various compositions have been proposed: a resin composition containing a silicone polymer powder comprising a silica and a polydiorganosiloxane and having an average particle diameter of from 1 to 1,000 μm (U.S. Pat. No. 5,391,594), a flame retardant resin composition comprising a thermoplastic resin and, added thereto, a mixture of a silicone and an inorganic substance (Unexamined Japanese Patent Application Laid-Open Specification No. Hei 11-140329), a resin composition comprising a polyphenylene ether and a silicone rubber powder comprising a polydiorganosiloxane gum and a silica and having an average particle diameter of from 1 to 1,000 μm (Unexamined Japanese Patent Application Laid-Open Specification No. Hei 5-230362), a resin composition comprising an amorphous thermoplastic resin, an oxide (such as silicon oxide) having an average particle diameter of 400 nm or less, and a flame retardant (EP 1169386), a resin composition comprising an aromatic polycarbonate, a metal or a metal compound each of which has an average particle diameter of from 0.1 to 100 nm, and a flame retardant (U.S. Pat. No. 5,849,827), a resin composition comprising a thermoplastic resin, a flame retardant, and an inorganic micropowder having an average particle diameter of 100 nm or less (Unexamined Japanese Patent Application Laid-Open Specification No. Sho 53-25660), a flame retardant resin composition comprising an aromatic polycarbonate and, dispersed therein, an alumina-carried silica which is in a colloidal form (U.S. Pat. No. 5,274,017), and a resin composition comprising an aromatic polycarbonate, a hydrophobic silica having an average particle diameter of 10 μm or less, a fluorohydrocarbon, a metal complex and a pigment (U.S. Pat. No. 4,772,655). However, in the case of the techniques of these prior art patent documents, one of the following three properties becomes poor: the dispersibility of the inorganic compound particles in the polymer, the flame retardancy of the polymer composition and the heat stability of the polymer in the polymer composition. Therefore, it has been desired to develop a flame retardant useful for producing a flame retardant polymer composition which exhibits a performance higher than that of the flame retardant polymer compositions of the above-mentioned prior art patent documents.

In general, inorganic compound particles have active groups on their surfaces. Therefore, a polymer composition containing inorganic compound particles has posed a problem in that, when such a polymer composition is subjected to molding (wherein the polymer composition is melted at high temperatures), a heat decomposition or the like of the polymer occurs due to the presence of the inorganic compound particles, so that the various mechanical properties of the polymer composition become lowered. In an attempt to solve such problem, it has been proposed to treat the surfaces of inorganic compound particles with a polysiloxane or the like to thereby suppress the activity of the active groups (see, for example, U.S. Pat. No. 5,274,017). However, in the case of such proposal, the bonding between the inorganic compound particle and the polysiloxane or the like used for the surface treatment is effected only by a very weak interaction (a physical adsorption by the van der Waals forces, or a hydrogen bond), and therefore the inorganic compound particle and the polysiloxane or the like can be easily separated from each other when a polymer composition containing such inorganic compound particles having their surfaces coated with the polysiloxane or the like is melt-kneaded under conditions wherein the polymer composition is exposed to a high temperature and a high shearing force. As a result, problems have been posed in that, when the polymer composition is recycled, there occur a lowering of the mechanical properties of the polymer composition and a lowering of the appearance of a shaped article produced from the polymer composition.

### SUMMARY OF THE INVENTION

In this situation, the present inventors have made extensive and intensive studies with a view toward solving the above-mentioned problems of the prior art. As a result, it has unexpectedly been found that the above-mentioned objective can be attained by using a coated particulate flame retardant for a polymer, which comprises inorganic compound particles, each having, bonded to the surface thereof through a covalent bond, a coating compound so that the inorganic compound particle is coated with the coating compound, wherein the coated inorganic compound particles have an in situ-found number average particle diameter (α) in the range of from 1 to 1,000 nm, as measured with respect to the coated inorganic compound particles in a composition comprising a polymer having dispersed therein the coated inorganic compound particles. That is, it has unexpectedly been found that the above-mentioned coated particulate flame retardant has excellent dispersibility in a polymer and also has great advantages in that, partly because of its excellent dispersibility in the polymer, not only can the polymer have remarkably improved flame retardancy, but also excellent appearance can be imparted to a shaped article produced from a polymer composition comprising the polymer and the coated particulate flame retardant. Further, it has surprisingly been found that the above-mentioned coated particulate flame retardant is also advantageous in that the polymer can be prevented from suffering a lowering of stability thereof, especially heat stability, wherein the stability lowering of a polymer is likely to occur when the conventional, inorganic compound-containing flame retardants are used. The present invention has been completed based on these novel findings.

Accordingly, it is a primary object of the present invention to provide a coated particulate flame retardant which has excellent dispersibility in a polymer and which also has excellent properties in that, partly because of its excellent dispersibility in the polymer, not only can the polymer have remarkably improved flame retardancy, but also excellent appearance can be imparted to a shaped article produced from a polymer composition comprising the polymer and the coated particulate flame retardant, wherein the coated particulate flame retardant is also advantageous in that the polymer can be prevented from suffering a lowering of stability thereof, especially heat stability, wherein the stability lowering of a polymer is likely to occur when the conventional, inorganic compound-containing flame retardant are used.

The foregoing and other objects, features and advantages of the present invention will be apparent from the following detailed description and appended claims taken in connection with the accompanying drawings.

### BRIEF DESCRIPTION OF THE DRAWINGS

In the drawings:

FIG. 1(a) to FIG. 1(e) show examples of coating compounds each bonded to the surface of an inorganic compound particle through a covalent bond;

Each of FIG. 2(a) and FIG. 2(b) is a graph showing the results of the analysis of the distribution of silicon atoms in a shaped article,

wherein the analysis is performed by the electron probe microanalyzer method (EPMA method) in the thicknesswise direction of the shaped article,

wherein, in each graph, the region between the arrows shows the analysis data of the shaped article,

wherein, in the region, the greater the number of peaks, the greater the concentration of silicon atoms, and

wherein FIG. 2(a) and FIG. 2(b) are, respectively, the data of the shaped articles produced in Example 1 and Comparative Example 1;

FIG. 3 is a graph in which the two curves show the thermal decomposition behaviors of the compositions obtained, respectively, in Example 13 and Comparative Example 4 (the solid line (-) represents the thermal decomposition behavior of the composition obtained in Example 13 and the dotted line (----) represents the thermal decomposition behavior of the composition obtained in Comparative Example 4);

FIG. 4 is a graph in which the three curves show the thermal decomposition behaviors of the compositions obtained, respectively, in Example 14 and Comparative Examples 5 and 6 (the solid line (-) represents the thermal decomposition behavior of the composition obtained in Example 14, the dotted line (----) represents the thermal decomposition behavior of the composition obtained in Comparative Example 4, and the broken line (----) represents the thermal decomposition behavior of the composition obtained in Comparative Example 5); and

FIG. 5 is a graph in which the three curves show the thermal decomposition behaviors of the compositions obtained, respectively, in Example 15 and Comparative Examples 7 and 8 (the symbol ◯ represents the thermal decomposition behavior of the composition obtained in Example 15, the symbol ● represents the thermal decomposition behavior of the composition obtained in Comparative Example 7, and the symbol X represents the thermal decomposition behavior of the composition obtained in Comparative Example 8).

### DETAILED DESCRIPTION OF THE INVENTION

In one aspect of the present invention, there is provided a coated particulate flame retardant for a polymer, which comprises inorganic compound particles, each having, bonded to the surface thereof through a covalent bond, a coating compound so that the inorganic compound particle is coated with the coating compound,

wherein the coated inorganic compound particles have an in situ-found number average particle diameter (α) in the range of from 1 to 1,000 nm, as measured with respect to the coated inorganic compound particles in a composition comprising a polymer having dispersed therein the coated inorganic compound particles.

For easy understanding of the present invention, the essential features and various preferred embodiments of the present invention are enumerated below.

1. A coated particulate flame retardant for a polymer, which comprises inorganic compound particles, each having, bonded to the surface thereof through a covalent bond, a coating compound so that the inorganic compound particle is coated with the coating compound,

wherein the coated inorganic compound particles have an in situ-found number average particle diameter (α) in the range of from 1 to 1,000 nm, as measured with respect to the coated inorganic compound particles in a composition comprising a polymer having dispersed therein the coated inorganic compound particles.

2. The coated particulate flame retardant according to item 1 above, wherein the coated inorganic compound particles have a left-intact number average particle diameter (β) in the range of from 1 to 100 nm, as measured with respect to the primary particles of the coated inorganic compound particles.

3. The coated particulate flame retardant according to item 1 or 2 above, wherein the number of hydroxyl groups present on the surfaces of the coated inorganic compound particles is 2/nm² or less.

4. The coated particulate flame retardant according to any one of items 1 to 3 above, wherein the inorganic compound particle comprises a metal oxide.

5. The coated particulate flame retardant according to any one of items 1 to 4 above, wherein the coating compound comprises at least one compound selected from the group consisting of a silicon-containing compound, an aromatic group-containing compound, and a thermoplastic polymer.

6. A flame retardant polymer composition, which comprises:

(A) a coated particulate flame retardant comprising inorganic compound particles, each having, bonded to the surface thereof through a covalent bond, a coating compound so that the inorganic compound particle is coated with the coating compound, and

(B) a thermoplastic polymer,

the thermoplastic polymer (B) having the coated particulate flame retardant (A) dispersed therein,

wherein the coated inorganic compound particles have an in situ-found number average particle diameter (α) in the range of from 1 to 1,000 nm, as measured with respect to the coated inorganic compound particles dispersed in the thermoplastic polymer (B).

7. The flame retardant polymer composition according to item 6 above, wherein the coated inorganic compound particles have a left-intact number average particle diameter (β) in the range of from 1 to 100 nm, as measured with respect to the primary particles of the coated inorganic compound particles.

8. The flame retardant polymer composition according to item 6 or 7 above, wherein the number of hydroxyl groups present on the surfaces of the coated inorganic compound particles is 2/nm² or less.

9. The flame retardant polymer composition according to any one of items 6 to 8 above, wherein the inorganic compound particle comprises a metal oxide.

10. The flame retardant polymer composition according to any one of items 6 to 9 above, wherein the coating compound comprises at least one compound selected from the group consisting of a silicon-containing compound, an aromatic group-containing compound, and a thermoplastic polymer which is the same as or different from the thermoplastic polymer (B).

11. The flame retardant polymer composition according to any one of items 6 to 10 above, wherein the thermoplastic polymer (B) is comprised mainly of an aromatic polycarbonate.

12. The flame retardant polymer composition according to any one of items 6 to 11 above, which further comprises (C) a flame retardant other than the flame retardant (A).

13. The flame retardant polymer composition according to item 12 above, wherein the flame retardant (C) is a sulfur-containing flame retardant.

14. The flame retardant polymer composition according to item 13 above, wherein the sulfur-containing flame retardant comprises a metal salt of an organic sulfonic acid.

15. The flame retardant polymer composition according to item 12 above, wherein the flame retardant (C) comprises a metal salt of an organic sulfonic acid and a fluorine-containing polymer.

16. The flame retardant polymer composition according to item 12 above, wherein the amount of the flame retardant (A) is in the range of from 0.001 to 10 parts by weight, relative to 100 parts by weight of the thermoplastic polymer (B), and the amount of the flame retardant (C) is in the range of from 0.001 to 10 parts by weight, relative to 100 parts by weight of the thermoplastic polymer (B).

17. A shaped article produced by shaping the flame retardant polymer composition of any one of items 6 to 16 above.

Hereinbelow, the present invention is described in detail.

The coated particulate flame retardant of the present invention comprises inorganic compound particles, each having, bonded to the surface thereof through a covalent bond, a coating compound so that the inorganic compound particle is coated with the coating compound.

The coated particulate flame retardant of the present invention exhibits an improved dispersibility in a polymer by virtue of the fact that the inorganic compound particles are coated with the coating compound. In addition, since the active sites in the surfaces of the inorganic compound particles are deactivated by the coating compound, even when a shaped article which is produced from a flame retardant polymer composition containing the coated particulate flame retardant of the present invention is exposed to stringent environmental conditions, such as high temperatures and chemicals, adverse effects of the inorganic compound particles on the stability of the polymer in the flame retardant polymer composition are small.

For achieving the above-mentioned excellent effects of the present invention, it is necessary that, in the coated inorganic compound particles, the surface of each inorganic compound particle and the coating compound are bonded to each other through a covalent bond. When the coating compound is bonded to the surfaces of the inorganic compound particles only by, for example, physical adsorption or the like, disadvantages occur not only in that the active sites in the surfaces of the inorganic compound particles cannot be deactivated satisfactorily, but also in that, even when a satisfactory amount of the coating compound is adsorbed on the surfaces of the inorganic compound particles, the coating compound comes off during the production process for a polymer composition containing the coated inorganic compound particles, during which the coated inorganic compound particles are exposed to a high temperature and a high shearing force, and the coming-off of the coating compound causes problems such as a lowering of the dispersibility of the inorganic compound particles and a lowering of the flame retardancy and heat stability of the polymer.

For forming a covalent bond between the surface of each inorganic compound particle and the coating compound, it is required that the surfaces of the inorganic compound particles have a functional group which can form a covalent bond. A representative example of such a functional group is a hydroxyl group. The functional group present may be a group which is possessed inherently by the inorganic compound or may be a group which is possessed by an impurity contained in the inorganic compound.

When the functional group is a hydroxyl group, since a hydroxyl group can also function as an active group which causes thermal decomposition of the polymer, it is highly desirable that the hydroxyl groups are completely consumed by the formation of a covalent bond between the inorganic compound particle and the coating compound.

With respect to the coated particulate flame retardant of the present invention, it is required that the coated inorganic compound particles have an in situ-found number average particle diameter (α) in the range of from 1 to 1,000 nm, as measured with respect to the coated inorganic compound particles in a composition comprising a polymer having dispersed therein the coated inorganic compound particles. The in situ-found number average particle diameter (α) is preferably from 1 to 800 nm, more preferably from 1 to 500 nm, most preferably from 1 to 300 nm.

It is desired that the in situ-found number average particle diameter (α) of the coated inorganic compound particles is as small as possible in the above-mentioned range required in the present invention. By decreasing the in situ-found number average particle diameter (α) of the coated inorganic compound particles, it can be made possible to distribute a large number of the coated inorganic compound particles having very small diameters uniformly in the polymer, thereby providing advantages in that the efficiency of imparting flame retardancy to the polymer is improved and that the coated inorganic compound particles are less likely to exhibit agglomeration in the polymer composition, leading to an improvement in the appearance of a shaped article produced from the polymer composition.

With respect to the particle diameter distribution of the coated inorganic compound particles in a polymer, the number of coated inorganic compound particles each having a particle diameter which is 10 times or more as large as the in situ-found number average particle diameter (α) of the coated inorganic compound particles is preferably 20% or less, more preferably 10% or less, based on the total number of the coated inorganic compound particles.

In the present invention, the above-mentioned in situ-found number average particle diameter (α) can be measured by the following method. A shaped article is produced by shaping a composition comprising a polymer and the coated particulate flame retardant of the present invention. From the shaped article, a 1 μm thick flat specimen is cut out by ultramicrotomy, and a photomicrograph of the specimen is taken using a transmission electron microscope, followed by measurement of the particle diameters of 500 particles chosen in the obtained photomicrograph. An average of the particle diameters of the 500 particles is determined to thereby obtain an in situ-found number average particle diameter (α). Each of the coated inorganic compound particles in a polymer may be a primary particle or may be a secondary particle which is formed by agglomeration of two or more primary particles.

By adjusting the below-mentioned conditions (a) to (c) appropriately, the in situ-found number average particle diameter (α) of the coated inorganic compound particles can be controlled to a value in the above-mentioned range required in the present invention.

(a) The number average particle diameter of the primary particles of the coated inorganic compound particles,

(b) the degree of the coating of the inorganic compound particles with the coating compound, and

(c) the kneading conditions under which the components are melt-kneaded for producing the below-described flame retardant polymer composition containing the coated particulate flame retardant of the present invention.

With respect to the above-mentioned condition (b) (the degree of the coating of the inorganic compound particles with the coating compound), it should be noted that, when the amount of the coating compound used is increased, the agglomeration of the coated inorganic compound particles can be suppressed to achieve a uniform dispersion thereof, thereby enabling the in situ-found number average particle diameter (α) of the coated inorganic compound particles to be controlled to a value in a predetermined range.

With respect to the above-mentioned condition (c) (the kneading conditions under which the components are melt-kneaded for producing the flame retardant polymer composition), it should be noted that, when the sharing force for the kneading and the kneading time are increased, the agglomeration of the coated inorganic compound particles can be suppressed to achieve a uniform dispersion thereof, thereby enabling the in situ-found number average particle diameter (α) of the coated inorganic compound particles to be controlled to a value in a predetermined range.

The primary particles mentioned in the above-mentioned condition (a) are particles each comprised of a strongly cohered form of the inorganic compound. A primary particle cannot be divided into smaller particles under ordinary heat processing conditions for a thermoplastic polymer; in this respect, the term “primary particle” means a particle of a minimum size.

In the present invention, it is preferred that the coated inorganic compound particles have a left-intact number average particle diameter (β) in the range of from 1 to 100 nm, as measured with respect to the primary particles of the coated inorganic compound particles. It is more preferred that the coated inorganic compound particles have a left-intact number average particle diameter (β) in the range of from 1 to 50 nm. When the left-intact number average particle diameter (β) of the coated inorganic compound particles (i.e., the number average particle diameter of the primary particles of the coated inorganic compound particles) is controlled to a value in the above-mentioned preferred range, the in situ-found number average particle diameter (α) of the coated inorganic compound particles can be easily controlled to a value in the range of from 1 to 1,000 nm, as measured with respect to the coated inorganic compound particles in a composition comprising a polymer having dispersed therein the coated inorganic compound particles.

With respect to the primary particles of the coated inorganic compound particles, primary particles having a predetermined particle diameter can be obtained by adjusting appropriately the production conditions for the inorganic compound particles. For example, when the inorganic compound particles are produced by a dry process as mentioned below, by adjusting the amount ratio between the raw materials for the inorganic compound particles, a desired particle diameter of the primary particles of the coated inorganic compound particles can be obtained.

The left-intact number average particle diameter (β) of the primary particles of the coated inorganic compound particles is determined by the following method. First, the coated inorganic compound particles are dispersed in a solvent without causing agglomeration of the coated inorganic compound particles in the solvent, and then a photomicrograph of the coated inorganic compound particles is taken using a transmission electron microscope. (With respect to the type of the above-mentioned solvent, there is no particular limitation as long as the solvent can disperse the inorganic compound particles therein without occurrence of agglomeration of the coated inorganic compound particles. For example, the solvent can be appropriately selected from generally employed solvents, depending on the type of the coating compound employed and the like. As a specific example of a solvent, there can be mentioned ethanol.) Next, the area (S) of each of 500 particles selected from the coated inorganic compound particles in the photomicrograph is measured. Using the area (S), the particle dimeter of each coated inorganic compound particle is determined by the formula: (4S/π)^{0.5}. From the obtained particle diameters of the 500 coated inorganic compound particles, a left-intact number average particle diameter (β) is calculated.

Specific examples of inorganic compounds used for producing the coated particulate flame retardant of the present invention include (a) metal oxides, such as silicon oxide, aluminum oxide, iron oxide, cesium oxide, zinc oxide, titanium oxide, yttrium oxide, zirconium oxide, tin oxide, copper oxide, magnesium oxide, manganese oxide, molybdenum oxide, holmium oxide, cobalt blue (CoO.Al₂O₃), Al₂O₃/MgO and the like; (b) metals, such as iron, silicon, tungsten, manganese, nickel, platinum and the like; (c) carbonaceous materials, such as carbon black, graphite, silicon carbide, boron carbide, zirconium carbide and the like; (d) borates, such as zinc borate, zinc metaborate, barium metaborate and the like; (e) carbonates, such as zinc carbonate, magnesium carbonate, calcium carbonate, barium carbonate and the like; (f) acid-bases, such as calcium zinc molybdate, zinc molybdate, zinc phosphate and the like; and (g) organometallic compounds, such as metallophthalocyanine and the like. Of these, from the viewpoint of ease in producing inorganic compound particles which are suitable for use in producing the coated particulate flame retardant of the present invention and ease in conducting the surface treatment of the inorganic compound particles, metal oxides are preferred, and silicon oxide, aluminum oxide and titanium oxide are especially preferred. The above-mentioned inorganic compounds can be used individually or in combination.

With respect to metal oxides, which are preferably used for producing the coated particulate flame retardant of the present invention, particles of a metal oxide can be produced by a wet process or a dry process. However, from the viewpoint of ease in producing inorganic compound particles which are suitable for use in producing the coated particulate flame retardant of the present invention and the viewpoint of improving the dispersibility of the coated particulate flame retardant in a polymer, it is preferred that particles of a metal oxide are produced by a dry process. As an example of metal oxide particles produced by a dry process, there can be mentioned metal oxide particles disclosed in, for example, Unexamined Japanese Patent Application Laid-Open Specification No. 2000-24493 (corresponding to U.S. Pat. No. 5,460,701). Specific examples of such particles of a metal oxide include “Nanotech” (which is an ultrafine particle) (manufactured and sold by Nanophase Technology, U.S.A.) and a metal salt of molybdate (manufactured and sold by Sherwin-Williams, U.S.A.).

Among the inorganic compounds used in the present invention, silicon oxides are extremely preferred. As a silicon oxide, a synthetic silica is preferred. The synthesis methods for producing a synthetic silica can be roughly classified into a dry process and a wet process As examples of methods for producing a silica by the wet process, there can be mentioned a method in which an alkali metal silicate is reacted with an acid to form a silica, and a method in which an alkoxysilane is hydrolyzed to form a silica. As an example of a method for producing a silica by the dry process, there can be mentioned a method in which a silica halide is hydrolyzed at a high temperature in an oxyhydrogen flame, to form a silica. It is preferred that the synthetic silica obtained by such methods is amorphous. It is especially preferred that the synthetic silica is produced by the dry process.

A specific example of a wet process production method for producing a silica is a method in which a mineral acid is added to a mixture of water and an alkali metal silicate (for example, sodium silicate), at a temperature of from 60 to 90° C. The heating of water and the silicate may be performed either before the mixing therebetween or after the mixing therebetween. The alkali metal silicate is not particularly limited as long as it is an alkali metal salt or alkaline earth metal salt of a metasilicate or disilicate. It is preferred that the alkali metal is at least one metal selected from the group consisting of Li, Na, and K. It is also preferred that the alkaline earth metal is at least one metal selected from the group consisting of Ca, Sr, Ba, Be and Mg. Specific examples of mineral acids include HCl and H₂SO₄. As a reaction medium, there can be used an electrolyte (such as sodium sulfate).

As an example of a synthetic silica produced by the dry process, there can be mentioned the so-called “fumed silica”, which is a hydrophilic or hydrophobic fumed silica. The hydrophobic fumed silica is especially preferred. The hydrophobic fumed silica can be produced by a method disclosed in Unexamined Japanese Patent Application Laid-Open Specification No. 2000-86227. Specifically, Unexamined Japanese Patent Application Laid-Open Specification No. 2000-86227 discloses a method in which silicontetrachloride is subjected to hydrolysis at a high temperature by using hydrogen, oxygen and water to thereby obtain a fumed silica. For example, a volatile silicon compound as a raw material is fed to a burner together with a gaseous mixture containing a flammable gas and oxygen gas, to cause a thermal decomposition of the volatile silicon compound at a temperature of from 1,000 to 2,100° C., thereby obtaining a hydrophobic fumed silica. Examples of volatile silicon compounds as a raw material include SiH₄, SiCl₄, CH₃SiCl₃, CH₃SiHCl₂, HSiCl₃, (CH₃)₂SiCl₂, (CH₃)₃SiCl, (CH₃)₂SiH₂, (CH₃)₃SiH, and alkoxysilanes. Of these, halogenated silicon compounds are preferred, and SiCl₄ is particularly preferred. As a flammable gas, a gas which can generate water is preferred. Examples of flammable gases include hydrogen gas, methane and butane. As an oxygen-containing gas, oxygen gas, air or the like can be used.

It is preferred that the amount ratio between the volatile silicon compound and the gaseous mixture containing oxygen gas and a flammable gas (e.g., hydrogen gas) is adjusted so that the oxygen gas and the hydrogen gas are used in molar amounts which are, respectively, 2.5 to 3.5 times and 1.5 to 3.5 times the molar equivalents of the oxygen gas and the hydrogen gas, each relative to the volatile silicon compound. The term “molar equivalents of the oxygen gas and the hydrogen gas” means the stoichiometric equivalents of the oxygen gas and the hydrogen gas, which react with the raw material compound (i.e., the volatile silicon compound). When a hydrocarbon fuel, such as methane, is used as a flammable gas, the term “molar equivalent of the hydrogen gas” means the molar equivalent of the hydrocarbon fuel in terms of hydrogen. For decreasing the average particle diameter of a silica, it is preferred that hydrogen gas and oxygen gas are used in excess amounts, each relative to the amount of the volatile silicon compound, to decrease the amount ratio of the solid (the silica) to the gas (the oxygen gas and the hydrogen gas), thereby decreasing the frequency of the collisions among the solid particles and suppressing the particle growth caused by fusion.

A preferred example of a synthetic silica is the synthetic silica which is manufactured and sold by Nanophase Technology, U.S.A., wherein the synthetic silica is produced by the dry process. Another preferred example of a synthetic silica is “Polyhedral Oligomeric Silsesquioxane (POSS)” (manufactured and sold by Hybrid Plastics, U.S.A.), which is produced by an organic-inorganic hybrid method.

Hereinbelow, an explanation is made with respect to the coating compound used in the coated particulate flame retardant of the present invention.

With respect to the method for coating the surfaces of the inorganic compound particles, there is no particular limitation; however, it is preferred to use a method which employs a coating compound having a functional group which can be covalently bonded to the surface of the inorganic compound particle. It is preferred that the coating compound comprises at least one compound selected from the group consisting of a silicon-containing compound, an aromatic group-containing compound, an aromatic group- and silicon-containing compound and a thermoplastic polymer. An example of a coating method is a method which uses a synthetic silica, which is a most preferred inorganic compound in the present invention. In such coating method, the synthetic silica is subjected to surface treatment with a coating compound which is, for example, either a polymer having functional groups which can react with the silanol groups of the silica, or a silane coupling agent, to thereby form a covalent bond between the surface of the synthetic silica and the coating compound.

A thermoplastic polymer having a functional group which can react with the hydroxyl group of the inorganic compound can be used as a coating compound. In this case, such a thermoplastic polymer can be selected from the functional group-containing polymers which are mentioned below as examples of the thermoplastic polymer (B) which is used in the below-mentioned flame retardant polymer composition. When a thermoplastic polymer other than the thermoplastic polymer (B) which is used in the below-mentioned flame retardant polymer composition is used as a coating compound, it is preferred that the polymer used as the coating compound has a compatibility or exhibits an interaction with the thermoplastic polymer (B).

Examples of functional groups which can react with a hydroxyl group include an epoxy group, an isocyanate group, an ester group (such as a maleic acid ester group), an amino group, a carboxylic acid group, and a carboxylic acid anhydride group.

When a styrene polymer is used as the thermoplastic polymer (B), a preferred example of the coating compound is an epoxy-modified styrene polymer.

Another example of a coating compound which can react with the hydroxyl group of the inorganic compound is a silane coupling agent. A silane coupling agent is a compound represented by any one of the following formulae (1) to (3):

Rₘ—Si—Xₙ (1)

wherein:

each R independently represents an alkyl group having 1 to 20 carbon atoms, an alkoxy group having 1 to 20 carbon atoms, an acryloxy group, a methacryloxy group, an amino group, an aryl group having 6 to 20 carbon atoms, an alkylaryl group having 7 to 20 carbon atoms, an arylalkyl group having 7 to 20 carbon atoms, an arylmethacryloxy group having 10 to 20 carbon atoms, or an arylalkoxy group having 7 to 20 carbon atoms, wherein preferred are an alkyl group having 1 to 20 carbon atoms, an alkoxy group having 1 to 20 carbon atoms, an alkylaryl group having 7 to 20 carbon atoms, an arylalkyl group having 7 to 20 carbon atoms, an arylmethacryloxy group having 10 to 20 carbon atoms and an arylalkoxy group having 7 to 20 carbon atoms,

each X independently represents a halogen group, a methoxy group, an ethoxy group or a hydroxyl group, and

each of m and n is independently an integer of from 1 to 3, provided that m+n=4;

Y₃—Si—Si—Z₃ (2)

wherein:

each Y independently represents an alkyl group having 1 to 20 carbon atoms or an aryl group having 6 to 20 carbon atoms, and

each Z independently represents an alkyl group having 1 to 20 carbon atoms or an aryl group having 6 to 20 carbon atoms; and

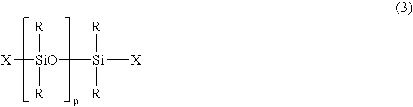

wherein:

each R is as defined for the formula (1) above,

each X independently represents a carboxyl group, a carbinol group, a mercapto group, a phenol group, an epoxy group, an amino group, an alkoxy group or a polyether group, and

p is an integer of 1 or more.

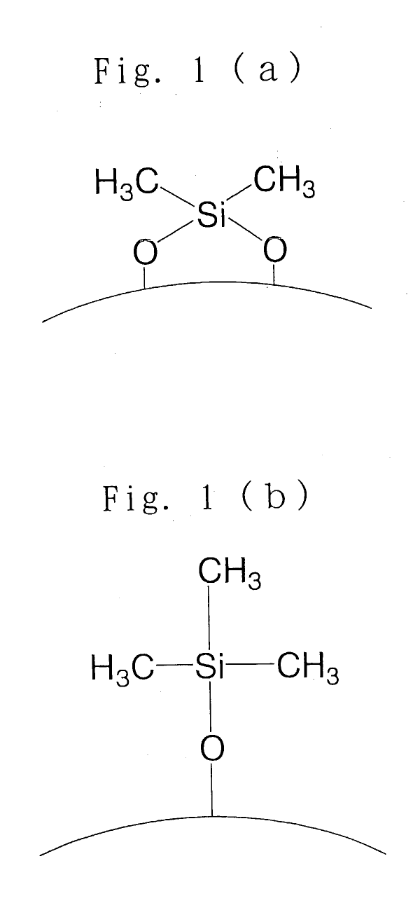

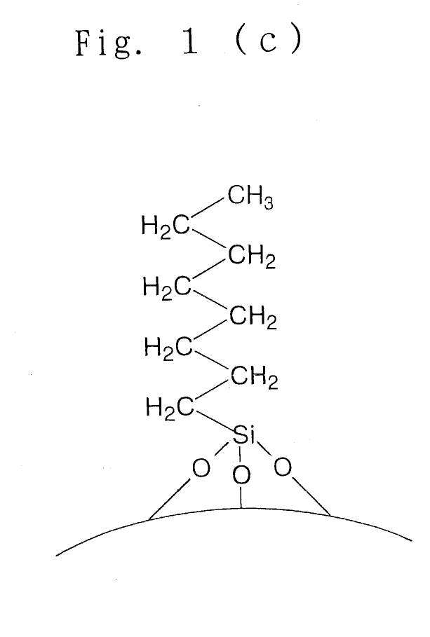

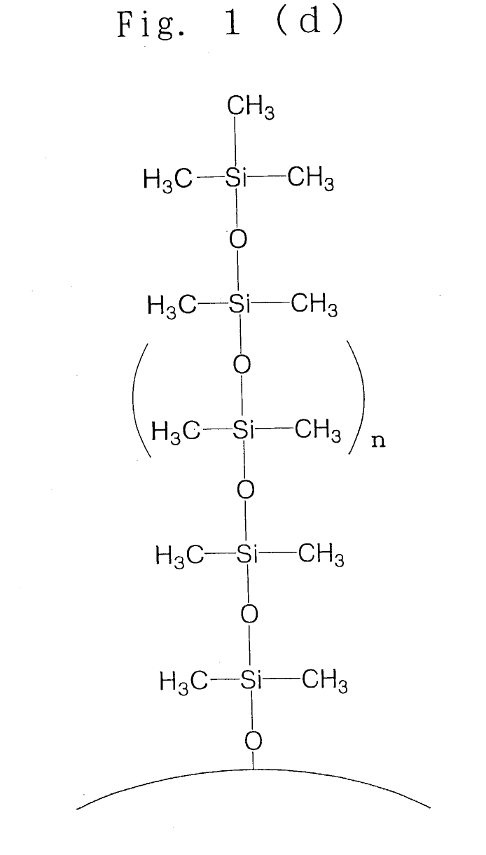

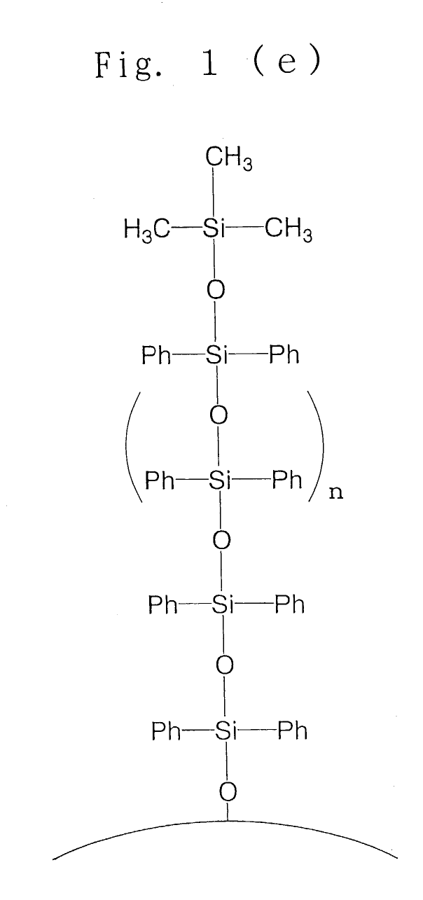

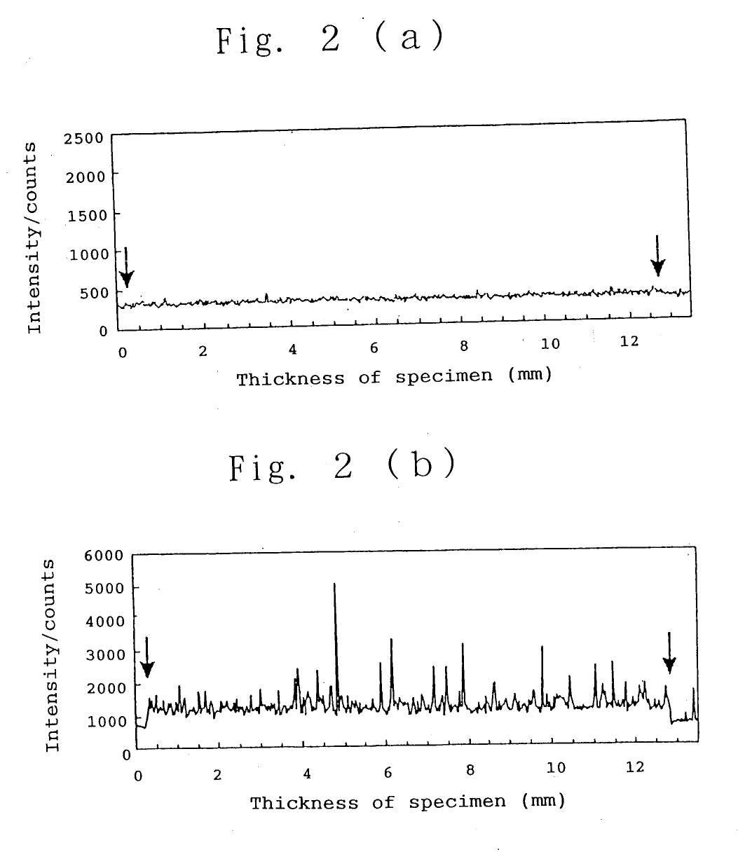

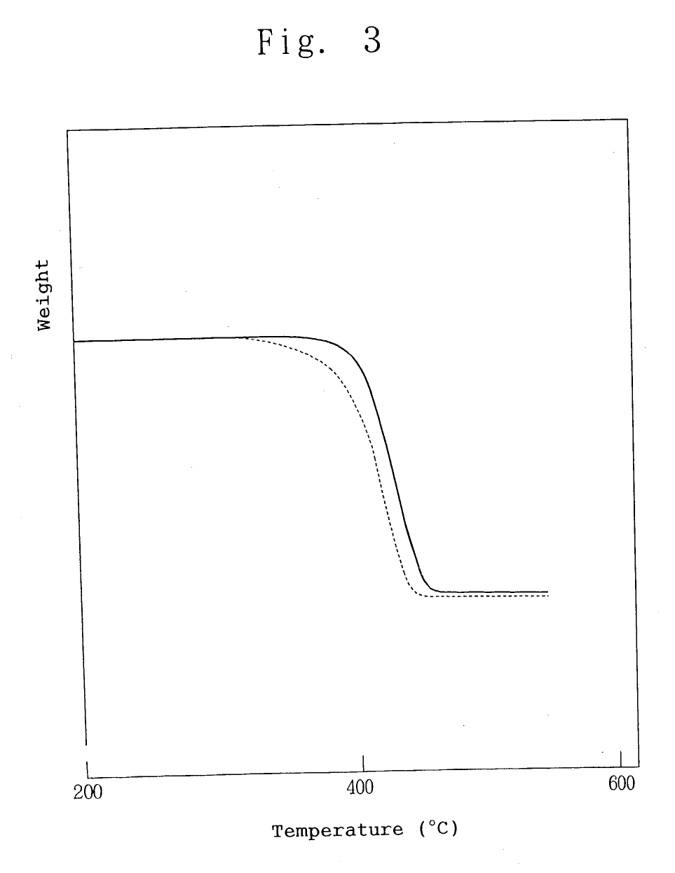

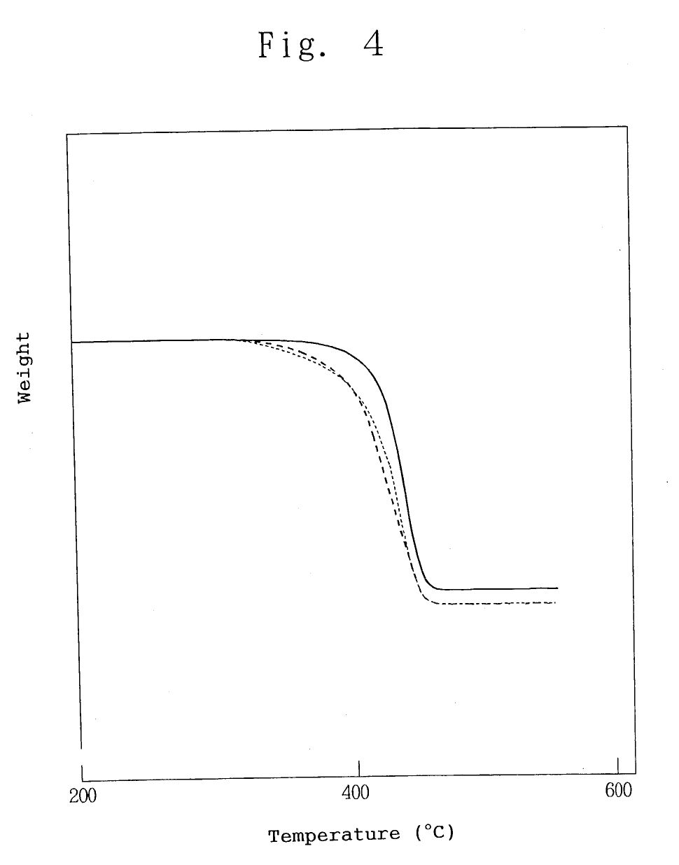

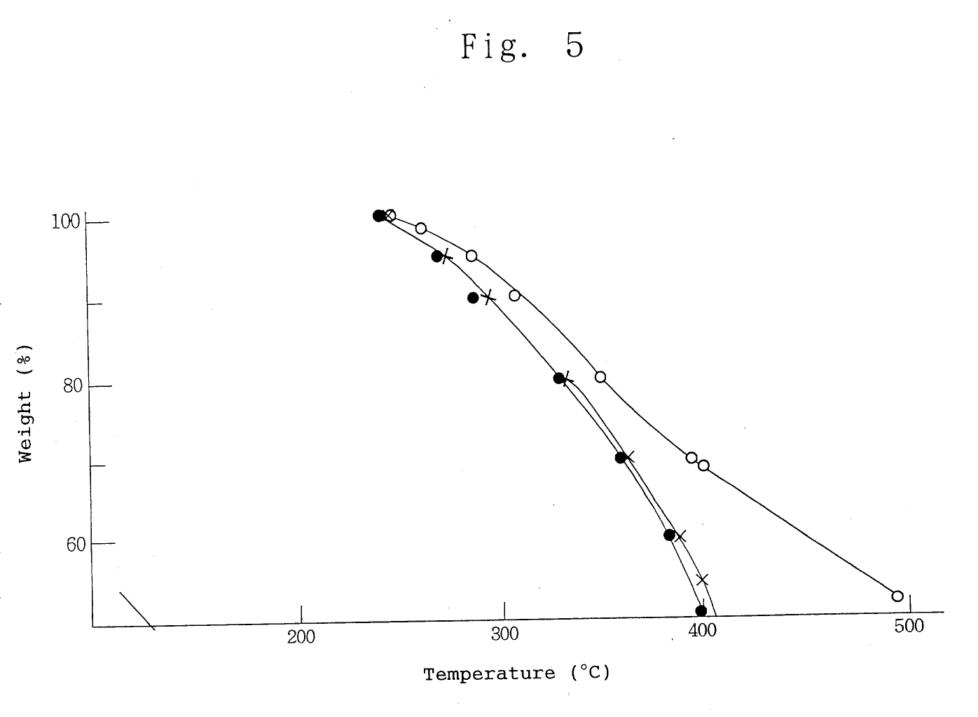

Examples of silane coupling agents include dimethyldichlorosilane, hexamethyldisilazane (FIG. 1(b) shows a state in which this silane coupling agent has been bonded to the surface of the inorganic compound particle by a method in which the inorganic compound particle is subjected to surface treatment (trimethylsilane treatment) using the silane coupling agent), octyltrichlorosilane (FIG. 1(c) shows a state in which this silane coupling agent has been bonded to the surface of the inorganic compound particle by a method in which the inorganic compound particle is subjected to surface treatment (octylsilane treatment) using the silane coupling agent), methacryloxytrichlorosilane, aminotrichlorosilane, dimethylsilicone oil, diphenyldichlorosilane, methylphenyldichlorosilane, hexaphenyldisilazane, phenylalkyldichlorosilane, phenylmethacryloxydichlorosilane, dichlorosilane, phenylaminodichlorosilane, phenyl group-containing polysiloxanetrichlorosilane, α-hydroxypolydimethylsiloxane (FIG. 1(d) shows a state in which this silane coupling agent has been bonded to the surface of the inorganic compound particle by a method in which the inorganic compound particle is subjected to surface treatment (dimethylsilicone treatment) using the silane coupling agent (in FIG. 1(d), n represents an integer of from 0 to 1,000)), α-hydroxypolydiphenylsiloxane (FIG. 1(e) shows a state in which this silane coupling agent has been bonded to the surface of the inorganic compound particle by a method in which the inorganic compound particle is subjected to surface treatment (diphenylsilicone treatment) using the silane coupling agent (in FIG. 1(e), Ph represents a phenyl group and n represents an integer of from 0 to 1,000)), polyethyleneglycol polydimethylsiloxane, diaminopolydimethylsiloxane, and diepoxypolydimethylsiloxane.

Particularly preferred examples of silane coupling agents include the below-mentioned compounds, each of which has a kinetic viscosity of from 10 to 1,000,000, more preferably 100 to 100,000 cs, still more preferably 100 to 10,000 cs, as measured at 25° C. in accordance with JIS-K2410: a modified polydiorganosiloxane, such as a modified polydimethylsiloxane or polymethylphenylsiloxane; a dialkyldihalosilane, such as dimethyldichlorosilane (FIG. 1(a) shows a state in which this silane coupling agent has been bonded to the surface of the inorganic compound particle by a method in which the inorganic compound particle is subjected to surface treatment (dimethylsilane treatment) using the silane coupling agent); an aromatic group-containing modified polydiorganosiloxane, such as a modified polyphenylsiloxane or modified polymethylphenylsiloxane; and an aromatic group-containing dihalosilane, such as diphenyldichlorosilane or phenylalkyldichlorosilane.

Examples of methods for bonding the coating compound to the surface of the inorganic compound particle through a covalent bond include the methods disclosed in Unexamined Japanese Patent Application Laid-Open Specification Nos. Hei 9-310027, Hei 9-59533 and Hei 6-87609. Specifically, for example, the coating compound can be covalently bonded to the surface of the inorganic compound particle by the following method. The inorganic compound particles are placed in a vessel equipped with an agitator, such as a Henschel mixer, and the coating compound is then added to the vessel while stirring (it is preferred that the coating compound is sprayed into the vessel, to thereby effect a uniform mixing between the inorganic compound particles and the coating compound), followed by stirring of the resultant mixture at a temperature of from 200 to 400° C. for 30 to 150 minutes to effect a reaction, thereby obtaining inorganic compound particles, each having, bonded to the surface thereof through a covalent bond, a coating compound.

U.S. Pat. No. 5,274,017 discloses a method in which the surfaces of inorganic compound particles are simply treated with a polysiloxane. By such a method, the bonding between the inorganic compound particles and the polysiloxane is effected only by a weak interaction (a physical adhesion using the van der Waals forces or the like). Therefore, the polysiloxane easily comes off from the inorganic compound particles when the inorganic compound particles coated with the polysiloxane are melt-kneaded together with a polymer at a high temperature and a high shearing force. As a result, problems are posed in that there occurs agglomeration of the inorganic compound particles or a heat decomposition of the polymer, thus leading not only to a lowering of the mechanical properties of the polymer but also to a poor appearance of a shaped article produced from the polymer composition. Also, there occurs a lowering of the flame retardancy of the polymer. These problems are clearly shown when a comparison is made between Example 1 and Comparative Example 2 of the present specification.

When a thermoplastic polymer is used as a coating compound, the coating of the inorganic compound particles with the coating compound can be effected by a method in which a polymerizable monomer, such as styrene, is subjected to heat treatment or photoirradiation together with a free radical initiator or a photosensitizer in the presence of the inorganic compound particles, to thereby coat the surfaces of the inorganic compound particles with a polymer (such as polystyrene). With respect to the specific method for coating the inorganic compound particles with the coating compound, reference can be made to Y. Shirai, Journal of Polymer Science: Part A: Polymer Chemistry, vol. 39, 2157-2163 (2001); and N. Tsubokawa, Journal of Polymer Science: Part A: Polymer Chemistry, vol. 30, 2241-2246 (1992).

The above-mentioned “POSS” (synthetic silica) (manufactured and sold by Hybrid Plastics, U.S.A.) comprises a synthetic silica having its surface coated with a low molecular weight compound or a polymer, such as alcohol, phenol, amine, chlorosilane, epoxy, ester, fluoroalkyl, halide, isocyanate, methacrylate, acrylate, silicone, nitrile, norbornenyl, olefin, phosphine, silane, thiol and polystyrene.

With respect to the coated particulate flame retardant of the present invention, the presence of the covalent bond between the coating compound and the surface of the inorganic compound particle can be confirmed by the following method.

The weight (W₀) of inorganic compound particles before coating thereof with a coating compound is measured. After the measurement, the inorganic compound particles are coated with a coating compound, and the weight (W₁) of the resultant coated particulate flame retardant is measured. Then, the coated particulate flame retardant is subjected to heating in n-hexane under reflux conditions for 6 hours, thereby obtaining a mixture of an extraction liquid and residual coated particles. Thereafter, the extraction liquid is removed from the residual coated particles, and any n-hexane remaining in the residual coated particles is distilled off, followed by drying of the residual coated particles. Then, the weight (W₂) of the residual coated particles is measured. The value of W₁−W₀ is the total amount of the coating compound bonded to the surfaces of the inorganic compound particles through a covalent bond and the coating compound bonded to the surfaces of the inorganic compound particles not through a covalent bond. By the above-mentioned heating under reflux conditions, only the coating compound bonded to the surfaces of the inorganic compound particles not through a covalent bond comes off the inorganic compound particles and moves into the n-hexane. Therefore, the value of W₂−W₀ is the amount of the coating compound bonded to the surfaces of the inorganic compound particles through a covalent bond. Thus, by measuring the value of W₂−W₀, the presence of the covalent bond can be confirmed.

In the present invention, it is preferred that the amount of the coating compound bonded to the surfaces of the inorganic compound particles through a covalent bond is from 0.01 to 100% by weight, more advantageously from 0.1 to 100% by weight, still more advantageously from 1 to 50% by weight, still more advantageously from 5 to 50% by weight, most advantageously from 10 to 50% by weight, based on the weight of the inorganic compound particles.

When the inorganic compound particles are comprised of a metal oxide, the amount of the coating compound bonded to the surfaces of the inorganic compound particles through a covalent bond can be measured by determining the difference in the amount of the hydroxyl groups present on the surfaces of the inorganic compound particles as between before and after the coating of the inorganic compound particles with the coating compound.

With respect to the hydroxyl groups on the surfaces of the coated inorganic compound particles, for preventing the occurrence of agglomeration of the coated inorganic compound particles, it is preferred that the number of the hydroxyl groups present on the surfaces of the coated inorganic compound particles is 2/nm² or less, more advantageously 1.5/nm² or less, still more advantageously 1/nm² or less, most advantageously 0.5/nm² or less.

In the present invention, it is preferred that the coated particulate flame retardant of the present invention has an acid value of 1 mgKOH/g or less, more advantageously 0.7 mgKOH/g or less, still more advantageously 0.5 mgKOH/g or less, most advantageously 0.2 mgKOH/g or less, as measured in accordance with JIS-K6751. When the coated particulate flame retardant of the present invention has an acid value in the above-mentioned range, a stability lowering of the polymer due to the coated particulate flame retardant can be prevented.

Further, when the coated particulate flame retardant of the present invention contains a halogen atom as an impurity, it is preferred that the coated particulate flame retardant of the present invention has a halogen atom content of not greater than 1,000 ppm, more advantageously not greater than 500 ppm, still more advantageously not greater than 100 ppm, most advantageously not greater than 50 ppm. When the halogen atom content of the coated particulate flame retardant of the present invention is in the above-mentioned range, a stability lowering of the polymer due to the coated particulate flame retardant can be prevented.

Next, an explanation is made with respect to a flame retardant polymer composition prepared using the coated particulate flame retardant of the present invention.

The flame retardant polymer composition of the present invention comprises the above-mentioned coated particulate flame retardant (A) and the thermoplastic polymer (B), wherein the thermoplastic polymer (B) has the coated particulate flame retardant (A) dispersed therein, and wherein the coated inorganic compound particles have an in situ-found number average particle diameter (α) in the range of from 1 to 1,000 nm, as measured with respect to the coated inorganic compound particles dispersed in the thermoplastic polymer (B).

It is preferred that the polymer composition of the present invention further comprises a flame retardant (C) other than the coated particulate flame retardant (A). If desired, the polymer composition of the present invention may still further comprise at least one additive selected from the group consisting of a fibrous additive (D), a processing aid (E), and a light resistance improver (F).

The polymer composition of the present invention may contain two or more different types of coated particulate flame retardants (A) as long as these different types of coated particulate flame retardants satisfy the above-mentioned requirements defined in the present invention.

It is preferred that the amount of the coated particulate flame retardant (A) is in the range of from 0.001 to 100 parts by weight, more advantageously from 0.001 to 50 parts by weight, still more advantageously from 0.001 to 20 parts by weight, still more advantageously from 0.001 to 10 parts by weight, most advantageously from 0.001 to 1 part by weight, relative to 100 parts by weight of the thermoplastic polymer (B).

Even if the amount of the coated particulate flame retardant (A) is small, by decreasing the particle diameter of the coated particulate flame retardant (A), it is possible for a large number of the coated inorganic compound particles having very small diameters distribute uniformly in the polymer (B), thereby providing advantages in that the efficiency of imparting flame retardancy to the polymer (B) is improved and that the coated inorganic compound particles are less likely to exhibit agglomeration in the polymer composition, leading to an improvement in the appearance of a shaped article produced from the polymer composition.

Hereinbelow, in connection with the flame retardant polymer composition of the present invention, an explanation is made with respect to the components other than the coated particulate flame retardant (A).

Thermoplastic Polymer (B)

Preferred examples of thermoplastic polymers (B) used in the polymer composition of the present invention include aromatic vinyl polymers, polycarbonates, polyphenylene ethers, olefin polymers, vinyl chloride polymers, polyamides, polyesters, polyphenylene sulfides and methacrylic polymers. These thermoplastic polymers can be used individually or in combination. Aromatic vinyl polymers, polycarbonates and polyphenylene ethers are particularly preferred. Extremely preferred is a thermoplastic polymer comprised only of an aromatic polycarbonate or comprised mainly of an aromatic polycarbonate. As most preferred examples of such thermoplastic polymers, there can be mentioned a thermoplastic polymer blend comprising an aromatic polycarbonate and an aromatic vinyl polymer, and a thermoplastic polymer blend comprising an aromatic polycarbonate, an aromatic vinyl polymer and a polyphenylene ether.

The aromatic polycarbonate used as the component (B) in the composition of the present invention can be selected from the group consisting of aromatic homopolycarbonates carbonates and aromatic copolycarbonates. Examples of methods for producing the aromatic polycarbonate include a phosgene process in which phosgene is blown into a solvent containing a bifunctional phenolic compound and a caustic alkali, and a transesterification process in which, for example, a bifunctional phenolic compound and diethyl carbonate are subjected to a transesterification reaction in the presence of a catalyst. With respect to the molecular weight of the aromatic polycarbonate, it is preferred that the weight average molecular weight as measured by gel permeation chromatography (GPC) is in the range of from 10,000 to 100,000, more preferably from 10,000 to 30,000, most preferably from 15,000 to 25,000.

Examples of bifunctional phenolic compounds include 2,2′-bis(4-hydroxyphenyl)propane, 2,2′-bis(4-hydroxy-3,5-dimethylphenyl)propane, bis(4-hydroxyphenyl)methane, 1,1′-bis(4-hydroxyphenyl)ethane, 2,2′-bis(4-hydroxyphenyl)butane, 2,2′-bis(4-hydroxy-3,5-diphenyl)butane, 2,2′-bis(4-hydroxy-3,5-dipropylphenyl)propane, 1,1′-bis(4-hydroxyphenyl)cyclohexane, and 1-phenyl-1,1′-bis(4-hydroxyphenyl)ethane. 2,2′-bis(4-hydroxyphenyl)propane (i.e., bisphenol A) is particularly preferred. In the present invention, bifunctional phenolic compounds can be used individually or in combination.

It is preferred that the aromatic vinyl polymer used as the component (B) in the composition of the present invention is at least one aromatic vinyl polymer selected from the group consisting of a rubber-modified aromatic vinyl polymer, a non-rubber-modified aromatic vinyl polymer and a thermoplastic, aromatic vinyl elastomer.

The above-mentioned rubber-modified aromatic vinyl polymer is comprised of an aromatic vinyl polymer as a matrix and rubber particles dispersed in the aromatic vinyl polymer. The rubber-modified aromatic vinyl polymer can be obtained by graft-polymerizing an aromatic vinyl monomer and optionally a vinyl comonomer copolymerizable with the aromatic vinyl monomer, on a rubber polymer, using a customary method, such as a bulk polymerization method, a bulk suspension polymerization method, a solution polymerization method or an emulsion polymerization method.

Examples of rubber-modified aromatic vinyl polymers include high impact polystyrene, ABS resin (acrylonitrile/butadiene/styrene copolymer), AAS resin (acrylonitrile/acrylic rubber/styrene copolymer), AES resin (acrylonitrile/ethylene-propylene rubber/styrene copolymer) and the like.

The above-mentioned rubber polymer needs to have a glass transition temperature (Tg) of −30° C. or lower. If the rubber polymer has a glass transition temperature higher than −30° C., the impact resistance is lowered.

Examples of suitable rubber polymers include diene rubbers, such as polybutadiene, poly(styrene-butadiene) and poly(acrylonitrile-butadiene); saturated rubbers obtained by hydrogenating the diene rubbers, such as mentioned above; an isoprene rubber; a chloroprene rubber; acrylic rubbers, such as polybutyl acrylate; and an ethylene/propylene/diene terpolymer (EPDM). Diene rubbers are particularly preferred.

Preferred examples of aromatic vinyl monomers which are graft-polymerizable with the rubber polymer include styrene, α-methylstyrene and p-methylstyrene. Styrene is most preferred, but styrene can be used for copolymerization in combination with other aromatic vinyl monomers mentioned above.

If desired, at least one comonomer copolymerizable with the aromatic vinyl monomer can be introduced into the rubber-modified aromatic vinyl polymer used as the component (B). For obtaining a rubber-modified aromatic vinyl copolymer having excellent oil resistance, as a comonomer copolymerizable with the aromatic vinyl monomer, an unsaturated nitrile monomer, such as acrylonitrile or methacrylonitrile, can be used.

Also, for lowering the melt viscosity of the aromatic vinyl monomer, an acrylate comonomer having an alkyl group having 1 to 8 carbon atoms can be used as a comonomer. Further, for improving the heat resistance of the flame retardant polymer composition, other comonomers, such as α-methylstyrene, acrylic acid, methacrylic acid, maleic anhydride and N-substituted maleimide or the like, can be used as a comonomer. When the aromatic vinyl monomer is used in the form of a mixture with a comonomer copolymerizable therewith, the amount of the comonomer in the mixture (to be graft-polymerized on the rubber polymer) is generally in the range of from 0 to 40% by weight.

In the present invention, the content of the rubber polymer in the rubber-modified aromatic vinyl polymer is preferably in the range of from 5 to 80% by weight, more preferably from 10 to 50% by weight. The content of the aromatic vinyl monomer (or a mixture of the aromatic vinyl monomer and the comonomer copolymerizable therewith) in the rubber-modified aromatic vinyl polymer is preferably in the range of from 95 to 20% by weight, more preferably from 90 to 50% by weight. When the ratio of the rubber polymer to the aromatic vinyl polymer in the rubber-modified aromatic vinyl polymer is within the above-mentioned range, a good balance of impact resistance and stiffness can be achieved with respect to the flame retardant polymer composition to be obtained. The average diameter of the rubber particles in the rubber-modified aromatic vinyl polymer is preferably from 0.1 to 5.0 μm, more preferably from 0.2 to 3.0 μm. When the average rubber particle diameter is within the above-mentioned range, the impact resistance of the polymer composition is particularly enhanced.

With respect to the rubber-modified aromatic vinyl polymer, the reduced viscosity ηₛₚ/C (as measured in a 0.5 g/dl solution at 30° C.), which is a yardstick of the molecular weight, is preferably in the range of from 0.30 to 0.80 dl/g, more preferably from 0.40 to 0.60 dl/g, wherein, when the aromatic vinyl polymer is a polystyrene resin, toluene is used as the solvent and, when the aromatic vinyl polymer is an unsaturated nitrile/aromatic vinyl copolymer, methyl ethyl ketone is used as the solvent. In the production of the rubber-modified aromatic vinyl polymer, the reduced viscosity ηₛₚ/C can be controlled by appropriately selecting, for example, the amount of the initiator, the polymerization temperature and the amount of the chain transfer agent.

With respect to the method for producing the rubber-modified aromatic vinyl polymer, it is particularly preferred that the rubber-modified aromatic vinyl polymer is produced by a bulk polymerization which is performed by a method in which a polymerization feed stock solution comprising a rubber polymer, an aromatic vinyl monomer (or a mixture of an aromatic vinyl monomer and a comonomer copolymerizable therewith) and a polymerization solvent is continuously fed to a continuous multi-stage reactor for a bulk polymerization, which is equipped with an agitator, and polymerization and degasification are continuously performed, to thereby obtain a rubber-modified aromatic vinyl polymer. When the rubber-modified aromatic vinyl polymer is produced by a bulk polymerization method, the reduced viscosity ηₛₚ/C can be controlled by appropriately selecting the polymerization temperature, the type and amount of the initiator, the solvent and the amount of the chain transfer agent. When a mixture of an aromatic vinyl monomer and a comonomer copolymerizable therewith is used for producing the rubber-modified aromatic vinyl polymer, the mononer composition of the copolymer can be controlled by appropriately selecting the amounts of the aromatic vinyl monomer and the comonomer copolymerizable therewith. In addition, the average diameter of the rubber particles can be controlled by appropriately selecting the number of revolutions of the agitation element. Specifically, when the number of revolutions of the agitation element is increased, the average diameter of the rubber particles is decreased. When the number of revolutions of the agitation element is decreased, the average diameter of the rubber particles is increased.

Examples of thermoplastic, aromatic vinyl elastomers used as the component (B) in the composition of the present invention include a block copolymer comprised of aromatic vinyl monomer units and conjugated diene monomer units, and a hydrogenated block copolymer obtained by partially hydrogenating the conjugated diene moiety of the above-mentioned block copolymer.

Examples of aromatic vinyl monomers usable for forming the aromatic vinyl monomer units in the above-mentioned block copolymer include styrene, α-methylstyrene, p-methylstyrene, p-chlorostyrene, p-bromostyrene styrene, 2,4,5-tribromostyrene and the like. Styrene is most preferred, but styrene may be copolymerized with other aromatic vinyl monomers mentioned above.

Examples of conjugated diene monomers usable for forming the conjugated diene monomer units in the above-mentioned block copolymer include 1,3-butadiene, isoprene and the like.

With respect to the block configuration of the above-mentioned block copolymer, the block copolymer is preferably a linear block copolymer having a configuration of, for example, SB, S(BS)ₙ (wherein n represents an integer of from 1 to 3) or S(BSB)ₙ (wherein n represents an integer of 1 or 2), or a star-shaped block copolymer having a configuration of (SB)ₙX (wherein n represents an integer of from 3 to 6, and the B moieties form a linkage center portion). In the above configuration, S represents a polymer block comprised of aromatic vinyl monomer units, B represents a polymer block comprised of conjugated diene monomer units and/or a partial hydrogenation product thereof, and X represents a coupling agent residue (e.g., silicon tetrachloride, tin tetrachloride, or a polyepoxy compound). Among them, linear block copolymers having a diblock configuration “SB”, a triblock configuration “SBS”, and a tetrablock configuration “SBSB” are preferred.

A polyphenylene ether which is one example of the component (B) of the polymer composition of the present invention is a polymer and/or a copolymer, each of which has aromatic rings in the main chain thereof, wherein each of the aromatic rings is bonded through an ether linkage. Specific examples of polyphenylene ethers include poly(2,6-dimethyl-1,4-phenylene ether), a copolymer of 2,6-dimethylphenol and 2,3,6-trimethylphenol, and the like. Of them, poly(2,6-dimethyl-1,4-phenylene ether) is preferred. The method for producing such polyphenylene ether is not particularly limited. For example, polyphenylene ether can be readily produced by the method described in U.S. Pat. No. 3,306,874, in which, for example, 2,6-xylenol is subjected to oxidative polymerization, using as a catalyst a complex of copper(I) salt and an amine. Further, polyphenylene ether can also be readily produced by other methods described, for example, in U.S. Pat. No. 3,306,875, U.S. Pat. No. 3,257,357, U.S. Patent No. 3,257,358, Examined Japanese Patent Application Publication No. Sho 52-17880, and Unexamined Japanese Patent Application Laid-Open Specification No. Sho 50-51197. The reduced viscosity ηₛₚ/C (as measured in a 0.5 g/dl chloroform solution at 30° C.) of the polyphenylene ether used in the present invention is preferably in the range of from 0.20 to 0.70 dl/g, more preferably from 0.30 to 0.60 dl/g. As an example of a method for achieving the above-mentioned range of reduced viscosity of the polyphenylene ether, there can be mentioned a method in which the amount of a catalyst used in the production of the polyphenylene ether is appropriately chosen.

Flame Retardant (C) other than Coated Particulate Flame Retardant (A)

If desired, the polymer composition of the present invention (comprising the coated particulate flame retardant (A) and the thermoplastic polymer (B)) may contain a flame retardant (C) other than the flame retardant (A). As the flame retardant (C), there can be used at least one flame retardant selected from the group consisting of a sulfur-containing flame retardant, a halogen-containing flame retardant, a phosphorus-containing flame retardant, a nitrogen-containing flame retardant and a fluorine-containing polymer. In addition, an inorganic compound which does not fall in the definition of the coated particulate flame retardant of the present invention may be contained in the polymer composition as long as the flame retardancy of the polymer composition is not lowered.

Examples of sulfur-containing flame retardants usable as the above-mentioned flame retardant (C) include metal salts of organic sulfonic acids, such as potassium trichlorobenzenesulfonate, potassium perfluorobutanesulfonate, potassium diphenylsulfone-3-sulfonate; metal salts of aromatic sulfonimides; and sulfur-containing aromatic polymers, such as a styrene polymer and a polyphenylene ether each of which has either a structure in which a metal salt of sulfonic acid or sulfuric acid is bonded to an aromatic ring thereof or a structure in which a mixture of a phosphate and a sulfonate or a mixture of a borate and a sulfonate is bonded to an aromatic ring thereof (for example, an alkali metal salt of polystyrenesulfonic acid). When a polycarbonate is used as the polymer (B), the above-mentioned sulfur-containing flame retardants promote a decarboxylation reaction when the shaped article is on fire, thereby improving the flame retardancy of the shaped article. When the alkali metal salt of polystyrenesulfonic acid is used as a sulfur-containing flame retardant, the sulfonic acid metal salt portions of the alkali metal salt of polystyrenesulfonic acid function as crosslinking points when the shaped article is on fire, thereby greatly contributing to the formation of a char coating.

Examples of halogen-containing flame retardants as the flame retardant (C) include a bisphenol halide, a polycarbonate halide, an aromatic vinyl polymer halide, a cyanurate halide-containing resin and a polyphenylene ether halide. Of these, preferred are decabromodiphenyloxide, tetrabromobisphenol A, an oligomer of tetrabromobisphenol A, a bisphenol bromide-containing phenoxy resin, a bisphenol bromide-containing polycarbonate, polystyrene bromide, crosslinked polystyrene bromide, polyphenylene oxide bromide, polydibromophenylene oxide, a condensation product of decabromodiphenyloxide and a bisphenol, a halogen-containing phosphate and the like.

Examples of phosphorus-containing flame retardants usable as the flame retardant (C) include a phosphine, a phosphine oxide, a bisphosphine, a phosphonium salt, a phosphinic acid salt, a phosphoric ester and a phosphorous ester. More specific examples of phosphorus-containing flame retardants include triphenyl phosphate, methylneopentyl phosphite, pentaerythritol diethyl diphosphite, methyl neopentyl phosphonate, phenyl neopentyl phosphate, pentaerythritol diphenyldiphosphate, dicyclopentyl hypodiphosphate, dineopentyl hypophosphite, phenylpyrocatechol phosphite, ethylpyrocatechol phosphate, dipyrocatechol hypodiphosphate, ammonium polyphosphate, phosphazene (such as aromatic group-containing phosphazene) and red phosphorus.

Of these phosphorus-containing flame retardants, organic phosphorus compounds are particularly preferred. Among the organic phosphorus compounds, more preferred are a monomeric aromatic phosphoric ester and a condensate of an aromatic phosphoric ester.

Representative examples of nitrogen-containing flame retardants usable as the flame retardant (C) are triazine structure-containing compounds. A nitrogen-containing flame retardant functions as a flame retardant auxiliary, relative to a phosphorus-containing flame retardant, so that the flame retardancy can be further improved by using the nitrogen-containing flame retardant in addition to the phosphorus-containing flame retardant. Specific examples of triazine structure-containing compounds include melamine, melam, melem, mellon (a product obtained by the ammonia-liberating reaction of melem at 600° C. or higher, in which three molecules of ammonia are liberated from three molecules of melem), melamine cyanurate, melamine phosphate, succinoguanamine, adipoguanamine, methylglutaroguanamine, a melamine resin and a BT resin. Of these, melamine cyanurate is preferred from the viewpoint of less volatility.

Fluorine-containing polymers as the flame retardant (C) are used for preventing the dripping of flaming particles from a shaped article when the shaped article is on fire. A fluorine-containing polymer is used as a fibrous flame retardant. For realizing the incorporation of the fibrous flame retardant in the polymer composition, there are two methods, namely, a method in which the fibrous flame retardant is produced before the production of the polymer composition and then added to and melt-kneaded with components (A) and (B), and a method in which the non-fibrous material for the fibrous flame retardant is added to and melt-kneaded with components (A) and (B), thereby causing the material to have a fibrous form during the melt-kneading. Specific examples of fluorine-containing polymers include polymonofluoroethylene, polydifluoroethylene, polytrifluoroethylene, polytetrafluoroethylene and a tetrafluoroethylenehexafluoropropylene copolymer. If desired, a comonomer which is copolymerizable with the above-mentioned fluorine-containing monomer is used in combination with the fluorine-containing monomer.

The compounds mentioned as the flame retardant (C) are used individually or in combination.

The amount of the flame retardant (C) is in the range of from 0.001 to 100 parts by weight, preferably from 0.001 to 50 parts by weight, more preferably from 0.001 to 20 parts by weight, still more preferably from 0.001 to 10 parts by weight, most preferably from 0.001 to 1 part by weight, relative to 100 parts by weight of the polymer (B).

Fibrous Additive (D)

If desired, the polymer composition of the present invention (comprising the coated particulate flame retardant (A) and the thermoplastic polymer (B)) may contain a fibrous additive (D). The component (D) is not particularly limited. Herein, the term “fibrous additive” is used in a broad sense which covers anisotropic fillers including a filler in a plate form. It is preferred that the average fiber diameter of the fibrous additive (D) is from 0.01 to 1,000 μm, more advantageously from 0.1 to 500 μm, still more advantageously from 1 to 100 μm, most advantageously from 5 to 50 μm. It is preferred that the aspect ratio (length/diameter) of the fibrous additive (D) is from 2 to 10,000, more advantageously from 50 to 500, still more advantageously from 50 to 300, most advantageously from 100 to 200.

When the average fiber diameter of the fibrous additive (D) is less than 0.01 μm, the reinforcing effect of the fibrous additive (D) is poor and hence the improvement in the mechanical strength of the polymer composition tends to become small. On the other hand, when the average fiber diameter of the fibrous additive (D) is more than 1,000 μm, the dispersibility of the fibrous additive (D) in the polymer composition becomes poor and hence the improvement in the mechanical strength of the polymer composition tends to become small. When the aspect ratio (length/diameter) of the fibrous additive (D) is less than 2, the anisotropic effect of the fibrous additive (D) is unsatisfactory, so that the flame retardancy improvement and the reinforcing effect tend to be small. On the other hand, when the aspect ratio (length/diameter) of the fibrous additive (D) is more than 10,000, the fiber is broken into short lengths during the melt-kneading of the polymer composition, so that the reinforcing effect tends to be lost.

Specific examples of the above-mentioned fibrous additive (D) include a natural fiber, such as cotton, silk, wool, flax and the like; a regenerated fiber, such as a rayon, a cuprammonium rayon and the like; a semi-synthetic fiber, such as an acetate fiber, a promix fiber and the like; a synthetic fiber, such as a polyester fiber, a polyacrylonitrile fiber, a polyamide fiber, an aramid fiber, a polyolefin fiber, a carbon fiber, a vinyl fiber and the like; an inorganic fiber, such as a glass fiber, an asbestos fiber and the like; a metal fiber; and a filler in a plate form, such as a talc, a kaolin, a clay compound and the like.

Of these, an aramid fiber, a polyacrylonitrile fiber and a glass fiber are preferred as the fibrous additive (D).

The above-mentioned aramid fiber can be produced by a method in which isophthalamide or polyparaphenylene terephthalamide is dissolved in an amide-containing polar solvent or sulfuric acid, and the resultant solution is subjected to wet spinning or dry spinning.

The polyacrylonitrile fiber can be produced by a dry spinning method in which an acrylonitrile polymer is dissolved in a solvent (such as dimethylformamide), and the resultant solution is subjected to spinning under the flow of air at 400° C., or by a wet spinning method in which an acrylonitrile polymer is dissolved in a solvent (such as nitric acid), and the resultant solution is subjected to spinning in water.

By a method in which the surface of the fibrous additive (D) is treated with maleic acid anhydride or a silane coupling agent, the reinforcing effect of the fibrous additive (D) can be improved.

The amount of the component (D) is generally from 0.1 to 200 parts by weight, preferably from 1 to 150 parts by weight, more preferably from 10 to 100 parts by weight, still more preferably from 20 to 100 parts by weight, most preferably from 30 to 70 parts by weight, relative to 100 parts by weight of the polymer (B).

Processing Aid (E)

For improving the dispersibility of the coated particulate flame retardant (A) or the molding property (such as melt fluidity or mold release property) of the polymer composition (comprising the coated particulate flame retardant (A) and the polymer (B)), the polymer composition may contain a processing aid (E). As the processing aid (E), there can be used at least one processing aid selected from the group consisting of a polyolefin wax (such as a polyethylene wax), an aliphatic hydrocarbon (such as liquid paraffin), a higher fatty acid, a higher fatty acid ester, a higher fatty acid amide, a higher aliphatic alcohol, and a metallic soap.

The amount of the processing aid (E) is preferably from 0.1 to 20 parts by weight, more preferably from 0.5 to 10 parts by weight, most preferably from 1 to 5 parts by weight, relative to 100 parts by weight of the polymer (B).

Light Resistance Improver (F)

The polymer composition of the present invention (comprising the coated particulate flame retardant (A) and the thermoplastic polymer (B)) may contain a light resistance improver (F) for improving the light resistance of the coated particular flame retardant (A). As the light resistance improver (F), there can be used at least one light resistance improver selected from the group consisting of an ultraviolet light absorber, a hindered amine light stabilizer, an antioxidant, a halogen capturing agent, a sunproofing agent, a metal inactivating agent, and a light quenching agent.

The amount of the light resistance improver (F) is preferably from 0.05 to 20 parts by weight, more preferably from 0.1 to 10 parts by weight, most preferably from 0.2 to 5 parts by weight, relative to 100 parts by weight of the polymer (B).

For improving the functional characteristics of the polymer composition of the present invention (comprising the coated particulate flame retardant (A) and the thermoplastic polymer (B)), if desired, the polymer composition may further contain additives other than the additives mentioned above.

As an example of a most preferred combination of the thermoplastic polymer (B) and an optional component, there can be mentioned a combination wherein the thermoplastic polymer (B) is a polycarbonate or a polymer alloy which is mainly comprised of a polycarbonate, and the optional component is a flame retardant (C) which comprises one member selected from the group consisting of a sulfonate halide, an aromatic sulfonate, a mixture of a sulfonate halide and polytetrafluoroethylene (PTFE) and a mixture of an aromatic sulfonate and PTFE. Such a polymer composition exhibits an extremely excellent flame retardancy. In this case, the amount of the flame retardant (C) is preferably from 0.001 to 100 parts by weight, more preferably from 0.01 to 10 parts by weight, still more preferably from 0.01 to 1 part by weight, relative to 100 parts by weight of the polymer (B).

The flame retardant polymer composition of the present invention can be produced by conventional methods for producing a resin composition or a rubber composition, such as a method using a banbury mixer, a kneader, a single-screw extruder, a twin-screw extruder or the like. Of these, a method using a twin-screw extruder is preferred. A twin-screw extruder is suitable for continuously producing the polymer composition of the present invention. By using a twin-screw extruder, the component (A) and, optionally, the component (C) can be uniformly and finely dispersed in the component (B), followed by addition of the components (D) to (F).

With respect to the specific method for producing the flame retardant polymer composition of the present invention, there is no particular limitation. For example, the flame retardant polymer composition of the present invention can be produced as follows. The flame retardant (A) is dispersed in the polymer (B) so that the in situ-found number average particle diameter (α) of the coated inorganic compound particles is in the above-mentioned range, to obtain a polymer composition. Then, the obtained polymer composition is subjected to melt-extrusion. Alternatively, the flame retardant (A) and the polymer (B) are simultaneously melt-extruded so that the in situ-found number average particle diameter (α) of the coated inorganic compound particles is in the above-mentioned range. With respect also to the extrusion temperature, there is no particular limitation; however, it is preferred that the extrusion temperature is from 100 to 350° C., more preferably from 150 to 300° C.

For adjusting the in situ-found number average particle diameter (α) of the coated inorganic compound particles to the preferred range prescribed in the present invention, it is preferred to use a melt-extrusion method conducted by means of a twin-screw extruder which has an L/D value of from 5 to 100 (wherein L represents the length of the extruder as measured between the feeding inlet and the die and D represents the diameter of the screw). It is preferred that the twin-screw extruder has at least two inlets including a main feeding inlet and a side feeding inlet which are positioned at different distances from the forward end of the extruder, and that the twin-screw extruder has kneading zones positioned at a region between the two or more feeding inlets and at a region extending from the forward end of the extruder to the feeding inlet provided at a position adjacent to the forward end of the extruder, wherein each of the kneading zones independently has a length corresponding to 3D to 10D.

With respect to the production of the flame retardant polymer composition by the above-mentioned method, it is preferred that carbon dioxide is dissolved into the flame retardant polymer composition so as to lower the melt viscosity of the polymer composition. Such polymer composition exhibits excellent properties with respect to the dispersion of the components and the flame retardancy and stability of the polymer. It is more preferred that carbon dioxide is dissolved into the polymer composition so that the shear melt viscosity of the polymer composition is lowered by 10% or more, relative to the shear melt viscosity exhibited by the polymer composition having no carbon dioxide dissolved therein. As another preferred example of a method for producing the polymer composition, there can be mentioned a method in which a polymer composition having no carbon dioxide dissolved therein is produced, and then the polymer composition is melt-kneaded while introducing carbon dioxide thereinto.

As examples of methods for producing the polymer composition of the present invention, there can be mentioned:

a method in which the flame retardant (A) is mixed with the polymer (B), and the resultant mixture is melt-kneaded by means of an extruder;

a method in which the flame retardant (A) is melted in an extruder, and the polymer (B) is added to the melted flame retardant (A) in the extruder, and the resultant mixture is melt-kneaded by means of the extruder; and

a method in which a masterbatch containing the polymer (B) is produced, and then the flame retardant (A) is added to the masterbatch, followed by melt-kneading.

With respect to the above-mentioned method using carbon dioxide, reference can be made to WO 01/44351.

The polymer composition thus obtained can be used for producing various types of shaped articles by any of various conventional molding methods. Preferred examples of molding methods for producing shaped articles include an injection molding method, an extrusion molding method, a compression molding method, a blow molding method, a calendar molding method and a foam molding method. Of these, an injection molding method and an extrusion molding method are more preferred. It is preferred that, during the molding, carbon dioxide is dissolved into the polymer composition so as to lower the melt-viscosity of the polymer composition.

### BEST MODE FOR CARRYING OUT THE INVENTION

Hereinbelow, the present invention will be described in more detail with reference to the following Examples and Comparative Examples, which should not be construed as limiting the scope of the present invention.

In the following Examples and Comparative Examples, various properties were measured and evaluated as follows.

(1) Quantitative Determination of a Coating Compound Bonded to the Surfaces of Inorganic Compound Particles Through a Covalent Bond

The weight (W₀) of inorganic compound particles before coating thereof with a coating compound is measured. After the measurement, the inorganic compound particles are coated with a coating compound, and the weight (W₁) of the resultant coated particulate flame retardant is measured. Then, the coated particulate flame retardant is subjected to heating in n-hexane under reflux conditions for 6 hours, thereby obtaining a mixture of an extraction liquid and residual coated particles. Thereafter, the extraction liquid is removed from the residual coated particles, and any n-hexane remaining in the residual coated particles is distilled off, followed by drying of the residual coated particles. Then, the weight (W₂) of the residual coated particles is measured. The value of W₁−W₀ is the total amount of the coating compound bonded to the surfaces of the inorganic compound particles through a covalent bond and the coating compound bonded to the surfaces of the inorganic compound particles not through a covalent bond. By the above-mentioned heating under reflux conditions, only the coating compound bonded to the surfaces of the inorganic compound particles not through a covalent bond comes off the inorganic compound particles and moves into the n-hexane. Therefore, the value of W₂−W₀ is the amount of the coating compound bonded to the surfaces of the inorganic compound particles through a covalent bond. The thus obtained value of W₂−W₀ is used as the amount of the coating compound bonded to the surfaces of the inorganic compound particles through a covalent bond (the amount is expressed in % by weight, based on the weight of the inorganic compound particles before the coating).

(2) The in situ-found average particle diameter (α) of the coated inorganic compound particles (the number average particle diameter as measured with respect to the coated inorganic compound particles in a composition comprising a polymer having dispersed therein the coated inorganic compound particles) and the dispersion state of the coated inorganic compound particles

The in situ-found average particle diameter (α) is measured as follows. A flat square specimen having a size of 0.5 mm×0.5 mm×1 μm is cut out from each of the shaped articles obtained in the Examples and Comparative Examples, wherein the cutting out is performed by ultramicrotomy (see page 1436 of “Kagaku Daijiten (Encyclopedic Dictionary of Chemistry)”, published by TOKYO KAGAKU DOZIN CO., LTD., Japan, 1989). The surface of the specimen is scraped using a diamond knife so that the specimen becomes smooth. A photomicrograph of the thus treated specimen is taken using a transmission electron microscope (manufactured and sold by JEOL, LTD., Japan). From the inorganic compound particles which are shown in the photomicrograph, 500 particles are chosen, and the diameters of the 500 particles are determined as follows. The area S of each of the 500 particles is measured. Using the value of S, the particle diameter of each particle is obtained by the formula: (4S/π)^{0.5}. By averaging the thus obtained particle diameters of the 500 inorganic compound particles, the number average particle diameter is obtained.

On the other hand, the dispersion state of the coated inorganic compound particles is evaluated as follows. With respect to each of the shaped articles obtained in the Examples and Comparative Examples, the dispersion state of the coated inorganic compound particles in the shaped article is observed in the thicknesswise wise direction thereof by using the electron probe microanalyzer method (the EPMA method). By the EPMA method, the distribution of metal atoms can be analyzed. The measurement conditions are as follows:

Apparatus: EPMA-1600 (manufactured and sold by Shimadzu Corporation, Japan)

Electron beam conditions: 15 kV, 30 nA

Beam diameter: 10 μm

Analysis mode: linear analysis (stage scan method)

Step width: 5 μm/step

Integration time: 25 sec/step

(3) Quantitative Determination of the Hydroxyl Groups on the Surfaces of Inorganic Compound Particles

Inorganic compound particles are dried at 100° C. for 1 hour in a vacuum dryer. Then, the inorganic compound particles are dispersed in diethylene glycol dimethyl ether to obtain a mixture. Lithium aluminum hydride (LiAlH₄) is added to the obtained mixture little by little while observing the generation of hydrogen, and the addition is continued until the generation of hydrogen is no longer observed. The amount of the hydroxyl groups is determined based on the stoichiometric relationship between a hydroxyl group and LiAlH₄, which is represented by the following formula:

4R—OH+LiAlH₄→R—O—Li+(R—O)₃Al+4H₂

The surface area of the inorganic compound particles is measured by the BET Method (DIN-66131).

(4) Flame Retardancy

The self-extinguishing properties of a ⅛ inch-thick specimen are evaluated in accordance with the HB (Horizontal Burning) Method and the VB (Vertical Burning) Method which are described in UL-94. The criteria for the evaluation of the self-extinguishing properties using the VB Method of UL-94 are as follows.

⊚: self-extinguished within less than 20 seconds,

◯: self-extinguished within 20 to less than 40 seconds,

Δ: it takes 40 seconds or more for the specimen to be self-extinguished, and

X: totally burnt.

(5) Dispersibility of the Coated Particulate Flame Retardant (A)

The surface appearance of a ⅛ inch-thick specimen (each of the injection-molded articles obtained in the Examples and Comparative Examples) is visually observed and the dispersibility of the coated particulate flame retardant (A) in the specimen is evaluated by the following criteria:

⊚: very good,

◯: good,

Δ: some discrete particles are found, and

X: a number of discrete particles are found and the surface has a poor appearance.

(6) Heat Stability

The polymer compositions obtained in the Examples and Comparative Examples are individually subjected to injection molding using an injection molding machine (JSW-J100E-P, manufactured and sold by The Japan Steel Works, Ltd., Japan) at a cylinder temperature of 280° C. and a mold temperature of 60° C. (this molding is designated as a “molding without residence”). During the molding without residence, the required molding pressure P1 is measured. On the other hand, injection molding is performed in substantially the same manner as described above except that, before the injection into the mold, each polymer composition in molten form is allowed to reside in the injection molding machine for 30 minutes at a cylinder temperature of 280° C. (this molding is designated as a “molding after residence”). During the molding after residence, the required molding pressure P2 is measured. The ratio P2/P1 is used as an index of heat stability.

The greater the molecular weight lowering of the polymer due to the thermal history (residence at 280° C. for 30 minutes), the smaller the required molding pressure, i.e., the smaller the ratio P2/P1. In other words, the closer to 1 the ratio P2/P1, the higher the heat stability of the polymer composition.

As another index of heat stability, the thermal decomposition behavior of the polymer composition is measured. Specifically, the weight decrease ratio of the polymer composition is measured using a thermogravimetric analyzer DT-40 (manufactured and sold by Shimadzu Corporation, Japan) by a method in which the temperature of a specimen of the polymer composition is elevated at a rate of 40° C./min under a flow of nitrogen gas. The temperature at which the weight of the polymer composition decreases by 50% by weight is used as an index of heat stability.

(7) Flexural Modulus

The flexural modulus of a polymer composition is measured in accordance with JIS K6758 at a temperature of 23° C.

The materials used in Examples and Comparative Examples were as follows.

(a) Coated Particulate Flame Retardant (A) (Inorganic Compound Particles Coated with a Coating Compound)

For use as inorganic compound particles, a plurality of silica products having different average particle diameters are produced by a method in which silicon tetrachloride is subjected to a high temperature hydrolysis reaction in an oxyhydrogen flame, in substantially the same manner as in Unexamined Japanese Patent Application Laid-Open Specification No. 2000-86227. Specifically, 1.0 mol equivalent of silicon tetrachloride and a gaseous mixture of oxygen and hydrogen (2.69 mol equivalent of oxygen and 1.60 mol equivalent of hydrogen), wherein the gaseous mixture is preheated to a temperature of 60° C., are fed to a burner and burned at a temperature of 1,600° C. to produce fine particles of silica. In the above-mentioned production of silica, the average particle diameter of the silica is appropriately controlled by adjusting the molar equivalent ratios of the oxygen and hydrogen, relative to 1.0 mol equivalent of silicon tetrachloride.

Then, the silica is coated with a coating compound. The coating is conducted in substantially the same manner as in Unexamined Japanese Patent Application Laid-Open Specification Nos. Hei 9-310027, Hei 9-59533 and Hei 6-87609. Specifically, the above-mentioned silica is placed in a sealed type Henschel mixer. Then, the inside of the mixer is purged with nitrogen gas at room temperature under atmospheric pressure, and a coating compound is spray onto and mixed with the silica while stirring wherein the coating compound is used in an amount of 20 parts by weight, relative to 100 parts by weight of the silica. The resultant mixture is further stirred for 30 minutes while heating at a temperature of 25° C., and then cooled to room temperature, to obtain a surface-treated silica (i.e., coated inorganic compound particles). In the case of the coating of the silica with a polysiloxane, a modified polyorganosiloxane is used. The coated inorganic compound particles used in the Examples and Comparative Examples are shown in Tables 1 to 3.

With respect to the particulate silica products used in the Examples and Comparative Examples, the left-intact number average particle diameter, namely, the number average particle diameter of the primary particles was measured using a transmission electron microscope (manufactured and sold by JEOL LTD., Japan) by a method in which the particulate silica was dispersed in an appropriate solvent (a solvent which is suitable for dispersing the coated particulate silica without causing particle agglomeration was chosen, taking into consideration the type of the coating compound). With respect to each of the particulate silica products used in the Examples 1 to 12 and Comparative Examples 1 and 2, the measured number average particle diameter of the primary particles was 12 nm. With respect to the particulate silica used in Comparative Example 3, the measured number average particle diameter of the primary particles was 50 nm.

(b) Thermoplastic Polymer (B)

The thermoplastic polymers used in the Examples and Comparative Examples were as follows.

(i) Bisphenol A polycarbonate (PC) (weight average molecular weight: 27,000)

(ii) Rubber-modified polystyrene (HIPS) (ηsp/c=0.60 dl/g)

(iii) ABS resin (ABS) (ηsp/c=0.65 dl/g)

(iv) Polyphenylene ether (PPE) (ηsp/c=0.40 dl/g)

(v) TPV (TPV is a crosslinked thermoplastic polypropylene obtained by dynamic crosslinking conducted by melt-kneading and extruding a mixture of EPDM (ethylene/propylene/diene terpolymer), PP (polypropylene) and paraffin oil (weight ratio: 50/50/30), together with an organic peroxide and triallyl isocyanurate, by means of a twin-screw extruder.) Melt-flow rate (MFR): 0.2 g/10 mm (230° C., 2.16 kgf)

(c) Flame Retardant (C)

1) Salt of organic (aliphatic) sulfonic acid

Potassium perfluorobutanesulfonate (hereinafter referred to as “SF”)

2) Salt of organic (aromatic) sulfonic acid

Potassium diphenylsulfone-3-sulfonate (manufactured and sold by UCB Japan Co. Ltd., Japan) (hereinafter referred to as “ASF”)

3) Polytetrafluoroethylene

A product manufactured and sold by Daikin Industries, Ltd., Japan (hereinafter referred to as “PTFE”)

4) Bisphenol A-bis(diphenylphosphate)

Trade name: CR741, manufactured and sold by Daihachi Chemical Industry Co., Ltd., Japan (hereinafter referred to as “P1”)

(d) Glass Fiber (GF)

Glass fiber was produced in substantially the same manner as described in Japanese Patent Application No. 2002-029933. The average fiber diameter and the aspect ratio (length/diameter) of the obtained fiber, as measured in accordance with the method described in the above-mentioned patent document, were 13 μm and 230, respectively.

### EXAMPLES 1 to 16 AND COMPARATIVE EXAMPLES 1 to 8

In each of Examples 1 to 16 and Comparative Examples 1 and 3 to 8, the components indicated in Tables 1 to 5 were mixed together by means of a Henschel mixer to obtain a mixture. The obtained mixture was introduced into a twin-screw extruder (40 mmφ, L/D=47; wherein L represents the length from the inlet to the die, and D represents the diameter of the screw) having an inlet provided at a middle portion of the barrel thereof, and melt-extruded at 250° C., to thereby obtain a polymer composition. The screws used in the extruder were two double-threaded screws, each having mixing elements at a portion around the inlet of the extruder.

In Comparative Example 2, 0.3 part by weight of polydimethylsiloxane, relative to 100 parts by weight of the silica, was sprayed onto the silica in the Henschel mixer at room temperature, and the resultant mixture was stirred for about 15 minutes at room temperature, to obtain a coated particulate silica wherein the polydimethylsiloxane was evenly coated on the surfaces of the silica particles. Then, in substantially the same manner as in Examples 1 to 16 and Comparative Examples 1 and 3 to 8 except that the above-obtained coated particulate silica was used, the components indicated in Table 1 were mixed together by means of a Henschel mixer, and melt-extruded using a twin-screw extruder, to thereby obtain a polymer composition.

In each of Examples 1 to 16 and Comparative Examples 1 to 8, the thus obtained composition was subjected to injection molding at a cylinder temperature of 250° C. and a mold temperature of 60° C. to obtain a shaped article. The obtained shaped article was evaluated by the above-mentioned methods. The evaluation results are shown in Tables 1 to 5.

From the results shown in Tables 1 to 5, it is understood that, by the use of the coated particulate flame retardant of the present invention, which comprises inorganic compound particles, each having, bonded to the surface thereof through a covalent bond, a coating compound so that the inorganic compound particle is coated with the coating compound, it becomes possible not only to impart an excellent flame retardancy to a thermoplastic polymer, but also to prevent the thermoplastic polymer from suffering a lowering of heat stability thereof and obtain a shaped article having an excellent surface appearance.

TABLE 1

| | Compo- | | | Comparative | Comparative | Comparative |
|---|---|---|---|---|---|---|
| | nent | | Example 1 | Example 1 | Example 2 | Example 3 |
| Compo- | (A) | Inorganic compound | SiO₂ | SiO₂ | SiO₂ | SiO₂ |
| sition | | Amount (parts by | 0.3 | 0.3 | 0.3 | 0.3 |
| | | weight) | | | | |
| | | Average particle | 100 | 97 | 104 | 1500 |
| | | diameter (nm) | | | | |
| | | Coating compound | α-hydroxy polydi- | — | — | — |
| | | | methylsiloxane | | | |
| | | Number (per nm²) of | 0.6 | 2.5 | 2.4 | 2.7 |
| | | hydroxyl groups on the | | | | |
| | | surfaces of inorganic | | | | |
| | | compound particles | | | | |
| | (B) | Type | PC | PC | PC | PC |
| | | Amount (parts by | 100 | 100 | 100 | 100 |
| | | weight) | | | | |
| | (C) | Amount (parts by | — | — | 0.3 | — |
| | | weight) of polydi- | | | | |
| | | methylsiloxane | | | | |
| Evalua- | Amount (% by weight) of coat- | | 10.2 | 0 | 0 | 0 |
| tion | ing compound bonded to the | | | | | |
| | surfaces of inorganic compound | | | | | |
| | particles through a covalent | | | | | |
| | bond | | | | | |
| | Flame retardancy (HB Method) | | Self-extinguished | Totally burnt | Totally burnt | Totally burnt |
| | | | Foaming | No foaming | No foaming | No foaming |
| | | | occurred | occurred | occurred | occurred |
| | Disper- | Appearance of the | ⊚ | X | Δ | X |
| | sibil- | shaped article | | | | |
| | ity | Evaluation by the | See FIG. 2(a)* | See FIG. 2(b)* | | |
| | | EPMA method | Distribution un- | Distribution un- | | |
| | | | evenness is small | evenness is large | | |

| | | | | |
|---|---|---|---|---|
| Stability (Heat residence | 0.92 | 0.53 | 0.63 | 0.51 |
| test) P2/P1 ratio | | | | |

*Note for Table 1: In FIG. 2(a) and FIG. 2(b), the greater the number of detected peaks, the greater the degree of agglomeration of silicon. In the case of Example 1 (FIG. 2(a)), silicon atoms are substantially evenly distributed from one side to the other side of the shaped article in the thicknesswise direction. By contrast, in the case of Comparative Example 1 (FIG. 2(b)), uneven distribution due to agglomeration of silicon atoms is observed at a number of points.

TABLE 2

| | Compo- | | | | | |
|---|---|---|---|---|---|---|
| | nent | | Example 2 | Example 3 | Example 4 | Example 5 |
| Compo- | (A) | Inorganic compound | SiO₂ | SiO₂ | SiO₂ | SiO₂ |
| sition | | Amount (parts by | 0.3 | 0.3 | 0.3 | 0.3 |
| | | weight) | | | | |
| | | Average particle | 100 | 110 | 90 | 80 |
| | | diameter (nm) | | | | |
| | | Coating compound | dimethyldi- | hexamethyld- | octyltri- | α-hydroxy polydi- |
| | | | chlorosilane | isilazane | chlorosilane | phenylsiloxane |
| | (B) | Type | PC | PC | PC | PC |
| | | Amount (parts by | 100 | 100 | 100 | 100 |
| | | weight) | | | | |

| | | | | | |
|---|---|---|---|---|---|
| Evalua- | Amount (% by weight) of coating | 3.2 | 2.5 | 5.5 | 18.5 |
| tion | compound bonded to the surfaces | | | | |
| | of inorganic compound particles | | | | |
| | through a covalent bond | | | | |
| | Flame retardancy (HB Method) | Self- | Self- | Self- | Self- |
| | | extinguished | extinguished | extinguished | extinguished |

TABLE 3

| | Compo | | | | | | | |
|---|---|---|---|---|---|---|---|---|
| | nent | | Example 6 | Example 7 | Example 8 | Example 9 | Example 10 | Example 11 |
| Compo- | (A) | Inorganic compound | SiO₂ | SiO₂ | SiO₂ | SiO₂ | SiO₂ | SiO₂ |
| sition | | Amount (parts by | 0.3 | 0.3 | 0.3 | 0.3 | 0.3 | 0.3 |
| | | weight) | | | | | | |
| | | Average particle | 98 | 105 | 97 | 103 | 97 | 100 |
| | | diameter (nm) | | | | | | |
| | | Coating compound | α-hydroxy | α-hydroxy | α-hydroxy | α-hydroxy | α-hydroxy | α-hydroxy |
| | | | polydi- | polydi- | polydi- | polydi- | polydi- | polydi- |
| | | | methylsi- | methylsi- | methylsi- | methylsi- | methylsi- | methylsi- |
| | | | loxane | loxane | loxane | loxane | loxane | loxane |
| | (B) | Type | PC | PC | PC/ABS | HIPS | HIPS/PPE | ABS |
| | | Amount (parts by | 100 | 100 | 95/5 | 100 | 80/20 | 100 |
| | | weight) | | | | | | |
| | (C) | Type | SF | SF/PTFE | SF/PTFE | P1 | P1 | P1 |
| | | Amount (parts by | 0.3 | 0.3/0.3 | 0.3/0.3 | 5 | 5 | 5 |
| | | weight) | | | | | | |
| Evalua- | Amount (% by weight) of | | 10.2 | 10.2 | 10.2 | 10.2 | 10.2 | 10.2 |
| tion | coating compound bonded to | | | | | | | |
| | the surfaces of inorganic | | | | | | | |
| | compound particles through | | | | | | | |
| | a covalent bond | | | | | | | |
| | Flame retardancy (VB | | ◯ | ⊚ | ⊚ | ◯ | ⊚ | ◯ |
| | Method) | | | | | | | |
| | Dispersi- | Appearance of the | ⊚ | ◯ | ◯ | ⊚ | ⊚ | ⊚ |
| | bility | shaped article | | | | | | |

| | | | | | | |
|---|---|---|---|---|---|---|
| Stability (Heat residence | 0.91 | 0.93 | 0.91 | 0.85 | 0.87 | 0.82 |
| test) P2/P1 ratio | | | | | | |

TABLE 4

| | Component | | Example 12 | Example 13 |
|---|---|---|---|---|
| Compo- | (A) | Inorganic compound | SiO₂ | SiO₂ |
| sition | | Amount (parts by | 0.3 | 0.3 |
| | | weight) | | |
| | | Average particle | 105 | 100 |
| | | diameter (nm) | | |
| | | Coating compound | α-hydroxy | α-hydroxy |
| | | | polydimethyl- | polydimethyl- |
| | | | siloxane | siloxane |
| | (B) | Type | PC | PC |
| | | Amount (parts by | 100 | 100 |
| | | weight) | | |
| | (C) | Type | ASF/PTFE | ASF/PTFE |
| | | Amount (parts by | 0.3/0.3 | 0.3/0.3 |
| | | weight) | | |
| | (D) | Amount (parts by | 0 | 20 |
| | | weight) of GF | | |
| Eval- | Amount (% by weight) of | | 10.2 | 10.2 |
| uation | coating compound bonded to | | | |
| | the surfaces of inorganic | | | |
| | compound particles through a | | | |
| | covalent bond | | | |
| | Flame retardancy (VB Method) | | ⊚ | ⊚ |
| | Dispersi- | Appearance of the | ◯ | ◯ to Δ |
| | bility | shaped article | | |

| | | |
|---|---|---|
| Stability (Heat residence | 0.93 | 0.90 |
| test) P2/P1 ratio | | |
| Flexural modulus (MPa) | 1800 | 6100 |

TABLE 5

| | Compo- | | Compara. | | Compara. | | Compara. | Compara. | Example | Compara. |
|---|---|---|---|---|---|---|---|---|---|---|
| | nent | | Ex. 4 | Ex. 14 | Ex. 5 | Ex. 15 | Ex. 6 | Ex. 7 | 16 | Ex. 8 |
| Compo- | (A) | Inorganic | — | SiO₂ | — | SiO₂ | SiO₂ | — | SiO₂ | |
| sition | | compound | | | | | | | | |
| | | Amount (parts | — | 0.5 | — | 0.5 | 0.5 | — | 0.5 | |
| | | by weight) | | | | | | | | |
| | | Average particle | — | 110 | — | 105 | 1100 | — | 110 | — |
| | | diameter | | | | | | | | |
| | | (nm) | | | | | | | | |
| | | Coating | — | α-hydroxy | — | α-hydroxy | — | — | α-hydroxy | — |
| | | compound | | polydi- | | polydi- | | | polydi- | |
| | | | | methyl- | | methyl- | | | methyl- | |
| | | | | siloxane | | siloxane | | | siloxane | |

| (B) | Type | HIPS | | TPV |
|---|---|---|---|---|
| | Amount (parts | 100 | | 100 |
| | by weight) | | | |
| (C) | Type | — | P1 | — |
| | Amount (parts | — | 5 | — |
| | by weight) | | | |

| | | | | | | | | | |
|---|---|---|---|---|---|---|---|---|---|
| Evalua- | Amount (% by weight) of | 0 | 10.2 | 0 | 10.2 | 0 | 0 | 10.2 | 0 |
| tion | coating compound bonded | | | | | | | | |
| | to the surfaces of inorganic | | | | | | | | |
| | compound particles | | | | | | | | |
| | through a covalent bond | | | | | | | | |
| | Heat stability | | | | | | | | |
| | Temperature (° C.) at | 415 | 428 | 426 | 438 | 427 | 399 | 495 | 406 |
| | which a 50% weight | | | | | | | | |
| | reduction occurs | | | | | | | | |
| | Improvement ratio (%) | Refer- | 3 | Refer- | 3 | 0 | Refer- | 24 | 2 |
| | based on the case in | ence | | ence | | | ence | | |

| | | | |
|---|---|---|---|
| which (A) is not added | See FIG. 3 | See FIG. 4 | See FIG. 5 |

### Industrial Applicability

The coated particulate flame retardant of the present invention for a polymer exhibits excellent dispersibility in a polymer and also great advantages in that, partly because of its excellent dispersibility in the polymer, not only can the polymer have remarkably improved flame retardancy, but also the polymer can be prevented from suffering a lowering of stability thereof, especially heat stability, wherein the stability lowering of a polymer is likely to occur when the conventional, inorganic compound-coating flame retardants are used. When the coated particulate flame retardant of the present invention is melt-kneaded with a thermoplastic polymer, the resultant flame retardant polymer composition can be used to produce a shaped article in which the coated inorganic compound particles are less likely to exhibit agglomeration, leading to an improvement in the appearance of the shaped article.

The flame retardant polymer composition which comprises the coated particulate flame retardant of the present invention and a thermoplastic polymer can be advantageously used as a molding material in various fields, for example: housings, chassis or parts for household electric appliances, such as a VTR, a distribution switchboard, a television set, an audio player, a capacitor, a plug socket for domestic use, a radio cassette recorder, a video cassette recorder, a video disc player, an air conditioner, a humidifier and an electric hot-air supplier; housings, chassis or parts for office automation machines, such as a CD-ROM drive unit (mechanical chassis), a printer, a fax machine, a CRT, a word processor, a copying machine (such as a PPC), an electronic cash register, an office computer system, a floppy disk drive, a keyboard, a typewriter, an electric calculator, a toner cartridge and a telephone; electronic or electric parts, such as a connector, a coil bobbin, a switch, relay, a relay socket, an LED, a variable capacitor, an AC adapter, an FBT high-voltage bobbin, an FBT case, an IFT coil bobbin, a jack, a volume shaft and a motor part; and automobile parts, such as an instrument panel, a radiator grille, a cluster, a speaker grille, a louver, a console box, a defroster garnish, an ornament, a fuse box, a relay case and a connector shift tape. In the industries relating to such products, the flame retardant polymer composition of the present invention is very useful.

1. A coated particulate flame retardant for a polymer, which comprises inorganic compound particles, each having, bonded to the surface thereof through a covalent bond, a coating compound so that the inorganic compound particle is coated with said coating compound,
wherein the coated inorganic compound particles have an in situ-found number average particle diameter (α) in the range of from 1 to 1,000 nm, as measured with respect to said coated inorganic compound particles in a composition comprising a polymer having dispersed therein said coated inorganic compound particles.

2. The coated particulate flame retardant according to claim 1, wherein said coated inorganic compound particles have a left-intact number average particle diameter (β) in the range of from 1 to 100 nm, as measured with respect to the primary particles of said coated inorganic compound particles.

3. The coated particulate flame retardant according to claim 1 or 2, wherein the number of hydroxyl groups present on the surfaces of the coated inorganic compound particles is 2/nm² or less.

4. The coated particulate flame retardant according to any one of claims 1 to 3, wherein said inorganic compound particle comprises a metal oxide.

5. The coated particulate flame retardant according to any one of claims 1 to 4, wherein said coating compound comprises at least one compound selected from the group consisting of a silicon-containing compound, an aromatic group-containing compound, and a thermoplastic polymer.

6. A flame retardant polymer composition, which comprises:
(A) a coated particulate flame retardant comprising inorganic compound particles, each having, bonded to the surface thereof through a covalent bond, a coating compound so that said inorganic compound particle is coated with said coating compound, and
(B) a thermoplastic polymer,
said thermoplastic polymer (B) having said coated particulate flame retardant (A) dispersed therein,
wherein the coated inorganic compound particles have an in situ-found number average particle diameter (α) in the range of from 1 to 1,000 nm, as measured with respect to said coated inorganic compound particles dispersed in said thermoplastic polymer (B).

7. The flame retardant polymer composition according to claim 6, wherein said coated inorganic compound particles have a left-intact number average particle diameter (β) in the range of from 1 to 100 nm, as measured with respect to the primary particles of said coated inorganic compound particles.

8. The flame retardant polymer composition according to claim 6 or 7, wherein the number of hydroxyl groups present on the surfaces of said coated inorganic compound particles is 2/nm² or less.

9. The flame retardant polymer composition according to any one of claims 6 to 8, wherein said inorganic compound particle comprises a metal oxide.

10. The flame retardant polymer composition according to any one of claims 6 to 9, wherein said coating compound comprises at least one compound selected from the group consisting of a silicon-containing compound, an aromatic group-containing compound, and a thermoplastic polymer which is the same as or different from said thermoplastic polymer (B).

11. The flame retardant polymer composition according to any one of claims 6 to 10, wherein said thermoplastic polymer (B) is comprised mainly of an aromatic polycarbonate.

12. The flame retardant polymer composition according to any one of claims 6 to 11, which further comprises (C) a flame retardant other than said flame retardant (A).

13. The flame retardant polymer composition according to claim 12, wherein said flame retardant (C) is a sulfur-containing flame retardant.

14. The flame retardant polymer composition according to claim 13, wherein said sulfur-containing flame retardant comprises a metal salt of an organic sulfonic acid.

15. The flame retardant polymer composition according to claim 12, wherein said flame retardant (C) comprises a metal salt of an organic sulfonic acid and a fluorine-containing polymer.

16. The flame retardant polymer composition according to claim 12, wherein the amount of said flame retardant (A) is in the range of from 0.001 to 10 parts by weight, relative to 100 parts by weight of said thermoplastic polymer (B), and the amount of said flame retardant (C) is in the range of from 0.001 to 10 parts by weight, relative to 100 parts by weight of said thermoplastic polymer (B).

17. A shaped article produced by shaping said flame retardant polymer composition of any one of claims 6 to 16.
